(19) United States
(12) Patent Application Publication
(10) Pub. No.: US 2026/0257885 A1
(43) Pub. Date: Sep. 3, 2026

(54) DEVICE FOR WINDING UP SHEET-LIKE MEMBER

(71) Applicant: ASHIMORI INDUSTRY CO., LTD., Settsu-shi, Osaka (JP)

(72) Inventors: Soshi YASUDA, Settsu-shi, Osaka (JP); Yushi YOSHIDA, Settsu-shi, Osaka (JP)

(73) Assignee: ASHIMORI INDUSTRY CO., LTD., Settsu-shi, Osaka (JP)

(21) Appl. No.: 19/474,557

(22) PCT Filed: Apr. 12, 2024
(86) PCT No.: PCT/JP2024/014831

§ 371 Date: Oct. 10, 2025

(30) Foreign Application Priority Data
Apr. 14, 2023 (JP) 2023-066490
Jan. 5, 2024 (JP) 2024-000705

(51) Int. Cl. B65H 75/44; B60J 1/20; B65H 75/42; B65H 75/48

(52) U.S. Cl. CPC B65H 75/4431; B65H 75/425; B65H 75/4471; B65H 75/486; B60J 1/2033

(57) ABSTRACT

A sheet-shaped member winding device includes a sheet-shaped member, a winding shaft to which one end portion of the sheet-shaped member is attached, a housing including a locking side wall having a lock member disposition surface and a through hole, the housing being configured to support the winding shaft such that the winding shaft is rotatable in a state where an end portion of the winding shaft passes through the through hole, a biasing member configured to bias the winding shaft in a direction in which the sheet-shaped member is wound, and a lock member configured to be moved between a lock position and an unlock position on the lock member disposition surface side of the locking side wall.

### TECHNICAL FIELD

The present disclosure relates to a sheet-shaped member winding device.

### BACKGROUND ART

Patent Literature 1 discloses a technique in which a lock member of a shading device is used to prevent rotation of a shaft portion that winds a screen. The lock member is engaged with a lock position engagement portion of a housing, at a lock position. By operating a pair of operating portions of a lock portion, the engagement with the lock position engagement portion is released, and the lock portion can move to an unlock position.

### CITATION LIST

### Patent Literature

Patent Literature 1: JP2014-145171A

### SUMMARY OF INVENTION

### Technical Problem

However, according to the technique disclosed in Patent Literature 1, the pair of operating portions are operated in a direction in which the operating portions approach each other, and while maintaining the state, the lock member is slid in a direction orthogonal to the direction in which the operating portions approach each other to release the engagement with the lock position engagement portion. Therefore, there is a problem that workability is poor. When the lock member is in the lock position, a backlash of the lock member may occur.

Therefore, an object of the present disclosure is to make it possible to easily perform an unlock operation of a winding device and to prevent a backlash of a lock member.

### Solution to Problem

A sheet-shaped member winding device including:
a sheet-shaped member;
a winding shaft to which one end portion of the sheet-shaped member is attached;
a housing including a locking side wall having a lock member disposition surface and a through hole, the housing being configured to support the winding shaft such that the winding shaft is rotatable in a state where an end portion of the winding shaft passes through the through hole;
a biasing member configured to bias the winding shaft in a direction in which the sheet-shaped member is wound; and
a lock member configured to be moved between a lock position at which the lock member prevents rotation of the end portion of the winding shaft, and an unlock position at which the lock member allows rotation of the end portion of the winding shaft, on the lock member disposition surface side of the locking side wall,
in which the end portion of the winding shaft includes a rotation restricting portion whose rotation is restricted by the lock member, and the rotation restricting portion includes a first surface and a second surface that face in directions opposite to each other,
the lock member includes:
   an operating portion;
   a first intermediate portion and a second intermediate portion extending in the same direction from the operating portion with an interval between the first intermediate portion and the second intermediate portion;
   a first folded portion that is folded from a distal end of the first intermediate portion and folded toward a proximal end side of the first intermediate portion to pass through the second intermediate portion side;
   a second folded portion that is folded from a distal end of the second intermediate portion and folded toward a proximal end side of the second intermediate portion to pass through the first intermediate portion;
   a first lock portion extending from a distal end of the first folded portion along a direction in which the lock member moves; and
   a second lock portion extending from a distal end of the second folded portion along the direction in which the lock member moves,
the locking side wall includes a first holding portion and a second holding portion that are disposed with an interval between the first holding portion and the second holding portion, and the rotation restricting portion is disposed between the first holding portion and the second holding portion, and
in a state where the lock member is in the lock position, the first lock portion is disposed between the first surface and the first holding portion, and the second lock portion is disposed between the second surface and the second holding portion, and the first surface and the second surface push the first lock portion and the second lock portion in directions away from each other due to a rotational biasing force of the winding shaft by the biasing member, and
the first holding portion and the second holding portion restrict movement of the first lock portion and the second lock portion in the directions away from each other, thereby restricting rotation of the rotation restricting portion.

### Advantageous Effects of Invention

According to the present disclosure, the unlock operation of the winding device can be easily performed, and the backlash of the lock member can be prevented.

### BRIEF DESCRIPTION OF DRAWINGS

FIG. 1 is a side view illustrating a sheet-shaped member winding device according to a first embodiment.

FIG. 2 is a perspective view illustrating the winding device.

FIG. 3 is an exploded perspective view of a winding mechanism.

FIG. 4 is a partially enlarged view of FIG. 3.

FIG. 5 is a perspective view illustrating one end portion of the winding device when a lock member is in the lock position.

FIG. 6 is a cross-sectional view taken along line VI-VI of FIG. 5.

FIG. 7 is a perspective view illustrating one end portion of the winding device when the lock member is in an unlock position.

FIG. 8 is a cross-sectional view taken along line VIII-VIII of FIG. 7.

FIG. 9 is a diagram illustrating a state in which the lock member is being attached.

FIG. 10 is a partial perspective view illustrating a sheet-shaped member winding device according to a second embodiment.

FIG. 11 is an exploded perspective view of a winding mechanism.

FIG. 12 is an exploded perspective view of the winding mechanism.

FIG. 13 is a perspective view illustrating a bearing member.

FIG. 14 is a cross-sectional view taken along line XIV-XIV of FIG. 13.

FIG. 15 is a perspective view illustrating the bearing member.

FIG. 16 is a cross-sectional view taken along line XVI-XVI of FIG. 15.

FIG. 17 is a bottom view illustrating an operating portion and a receiving portion.

### DESCRIPTION OF EMBODIMENTS

### First Embodiment

Hereinafter, a sheet-shaped member winding device according to a first embodiment will be described.

### Overall Configuration

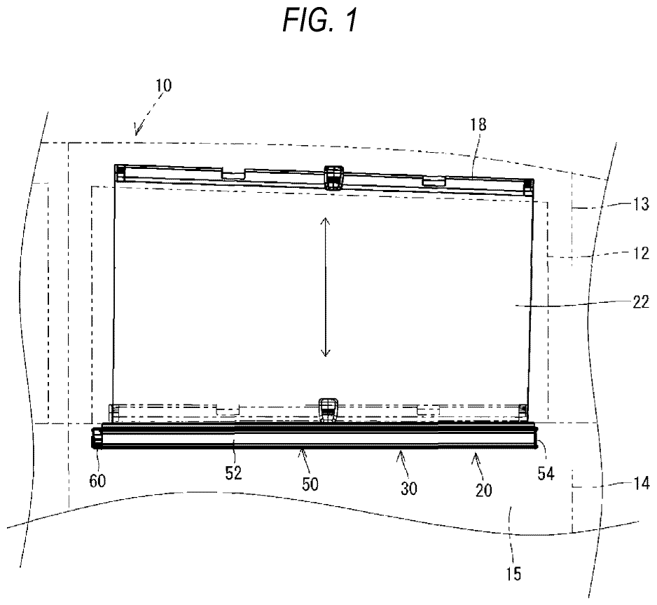

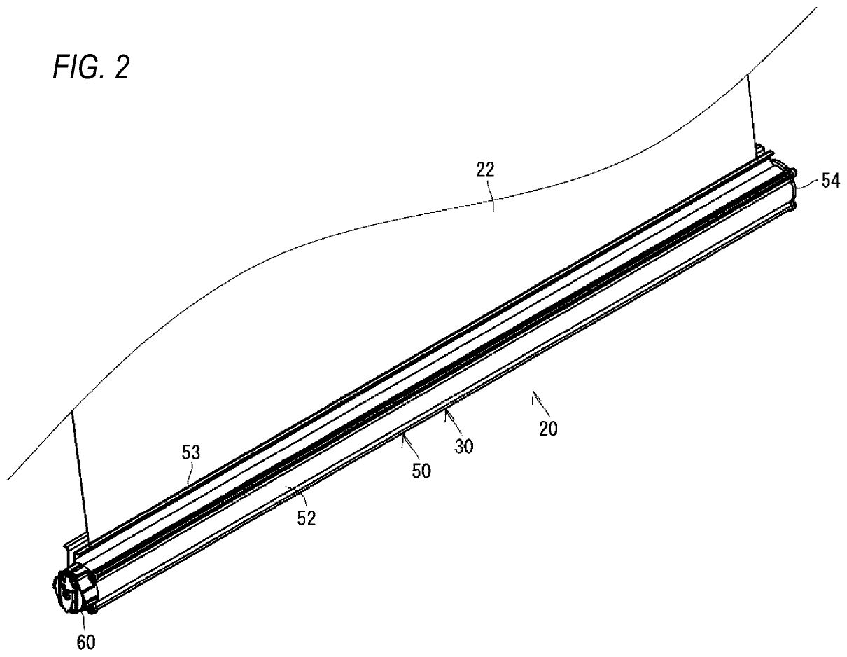

An overall configuration of the sheet-shaped member winding device will be described. FIG. 1 is a side view illustrating a sheet-shaped member winding device 20. FIG. 1 illustrates a part of an automobile 10 to which the winding device 20 is attached. FIG. 2 is a perspective view illustrating the winding device 20.

The sheet-shaped member winding device 20 is a device configured to wind a sheet-shaped member 22 in a drawable manner. In the present embodiment, an example will be described in which the sheet-shaped member 22 shades a window 12 of the automobile 10.

That is, a side door 14 of the automobile 10 includes a door body 15, the window 12 located above the door body 15, and a window frame 13 surrounding the window 12. The winding device 20 is located at an upper portion of the door body 15 on a vehicle interior side. The sheet-shaped member 22 can be drawn upward from the winding device 20 to cover the window 12 from the vehicle interior side. When the sheet-shaped member 22 is wound up by the winding device 20, the window 12 is exposed to the vehicle interior side.

The winding device 20 may be disposed above or beside the window 12. The sheet-shaped member 22 may be a tonneau cover that divides a trunk of an automobile into upper and lower parts, or may be a sheet that separates a passenger space and a trunk of an automobile.

The sheet-shaped member winding device 20 includes the sheet-shaped member 22 and a winding mechanism 30.

The sheet-shaped member 22 is a sheet-shaped member formed by cutting and sewing a cloth material, a mesh-shaped cloth material, a resin sheet, or the like. The sheet-shaped member 22 has such flexibility that the sheet-shaped member 22 can be wound around a winding shaft 40 to be described later. The sheet-shaped member 22 is formed in a shape and a size according to the application, here, in a shape and a size capable of partially or entirely shading the window 12. When the sheet-shaped member 22 is used for the purpose of light shielding or privacy protection, the sheet-shaped member 22 is preferably a light-shielding sheet. When the sheet-shaped member 22 is used for the purpose of preventing movement of an object, the sheet-shaped member may be a transparent sheet or a mesh sheet.

One end portion of the sheet-shaped member 22 is inserted into the winding mechanism 30 and attached to the winding shaft 40. A rod-shaped drawing member 18 for a drawing operation may be attached to the other end portion of the sheet-shaped member 22. The drawing member 18 may have a role of engaging with a portion located above the window 12, for example, an upper portion of the window frame 13 to maintain the sheet-shaped member 22 in a drawn-out state. The drawing member 18 may have a role of preventing excessive winding of the sheet-shaped member 22 by coming into contact with an edge of a drawing slit 53 of the winding device 20 from the outside.

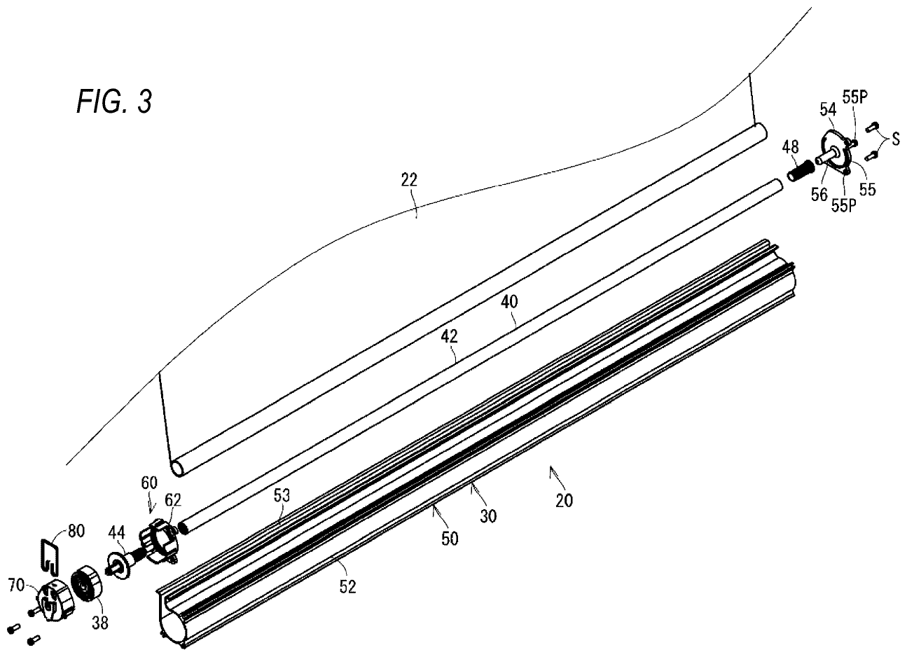

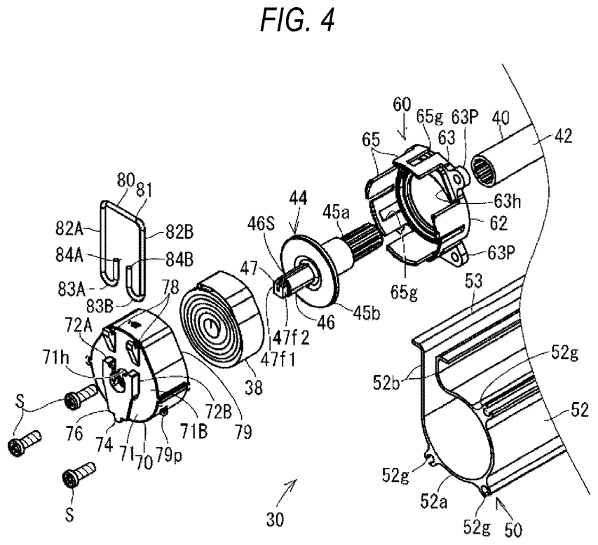

FIG. 3 is an exploded perspective view of the winding mechanism 30. FIG. 4 is a partially enlarged view of FIG. 3. The winding mechanism 30 includes the winding shaft 40, a housing 50, a biasing member 38, and a lock member 80.

The winding shaft 40 is an elongated member having a length equal to or greater than a width of the sheet-shaped member 22. The one end portion of the sheet-shaped member 22 is attached to the winding shaft 40. The sheet-shaped member 22 is wound around the winding shaft 40 as the winding shaft 40 rotates. The sheet-shaped member 22 is drawn out from the winding shaft 40, as the winding shaft 40 rotates in a direction opposite to the direction in which the sheet-shaped member 22 is wound.

More specifically, the winding shaft 40 includes a shaft body 42, a terminal member 44, and a terminal member 48.

The shaft body 42 is formed in an elongated tubular shape, which is cylindrical shape in the present embodiment. The shaft body 42 may be formed of, for example, a metal pipe.

The terminal member 44 is attached to one end portion of the shaft body 42, and the terminal member 48 is attached to the other end portion of the shaft body 42.

The terminal member 44 includes an insertion portion 45a, a flange portion 45b, an outer shaft portion 46, and a rotation restricting protrusion 47. The terminal member 44 is, for example, a resin component formed by injection molding.

The insertion portion 45a is an elongated portion to be inserted into the one end portion of the shaft body 42. The terminal member 44 is attached to the one end portion of the shaft body 42 such that the terminal member 44 is prevented from rotating with respect to the shaft body 42. For example, external teeth formed on an outer periphery of the insertion portion 45a mesh with internal teeth formed on an inner periphery of the shaft body 42, thereby preventing the insertion portion 45a from rotating with respect to the shaft body 42.

The configuration for preventing the rotation of the terminal member 44 with respect to the shaft body 42 is not limited to the above example. For example, a pin or a screw may pass through the shaft body and engage with the insertion portion, or the shaft body and the flange portion may engage with each other, thereby preventing the terminal member from rotating with respect to the shaft body.

The flange portion 45b is an annular portion protruding from a proximal end of the insertion portion 45a toward an outer peripheral side. In a state where the insertion portion 45a is inserted into the one end portion of the shaft body 42, the flange portion 45b abuts against one end surface of the shaft body 42, and the terminal member 44 is located in the shaft body 42 in a longitudinal direction thereof.

The outer shaft portion 46 is an elongated portion protruding to the side opposite to the insertion portion 45a with respect to the flange portion 45b. In a state where the insertion portion 45a is inserted into the one end portion of the shaft body 42, the outer shaft portion 46 extends outward from the one end portion of the shaft body 42. The outer shaft portion 46 is used to bias the shaft body 42 in the winding direction.

The rotation restricting protrusion 47 protrudes further outward from a distal end of the outer shaft portion 46. The rotation restricting protrusion 47 is used to restrict the rotation of the shaft body 42.

The outer shaft portion 46 and the rotation restricting protrusion 47 are an example of one end portion of the winding shaft 40.

The terminal member 48 is, for example, a resin component formed by injection molding. The terminal member 48 is formed in an elongated shape to be inserted into the other end portion of the shaft body 42. Similar to the terminal member 44, the terminal member 48 may be attached to the other end portion of the shaft body 42 such that the terminal member 48 is prevented from rotating with respect to the shaft body 42. A bearing hole that opens outward is formed in the terminal member 48.

The housing 50 includes a locking side wall 71 having a through hole 71h, and is configured to support the winding shaft 40 such that the winding shaft 40 is configured to be rotated in a state where the end portion of the winding shaft 40 passes through the through hole 71h.

More specifically, the housing 50 includes a housing body 52, a side cover 60, and a side cover 54.

The housing body 52 is formed in a shape having an internal space configured to accommodate the winding shaft 40 around which the sheet-shaped member 22 is wound. The housing body 52 is formed with the drawing slit 53 that connects the internal space with the outside.

For example, the housing body 52 includes a cylindrical portion 52a and a pair of slit-forming edges 52b. The cylindrical portion 52a is formed in a cylindrical shape configured to accommodate the winding shaft 40 around which the sheet-shaped member 22 is wound. A slit extending along an axial direction of the cylindrical portion 52a is formed in a part of the cylindrical portion 52a in a circumferential direction. The respective pair of slit-forming edges 52b extend outward from a pair of edges sandwiching the slit. The drawing slit 53 is formed between outer edges of the pair of slit-forming edges 52b.

The winding shaft 40 is rotatably accommodated in the cylindrical portion 52a. The sheet-shaped member 22 passes between the pair of slit-forming edges 52b from the drawing slit 53 and is wound around the winding shaft 40. Alternatively, the sheet-shaped member 22 wound around the winding shaft 40 is drawn from between the pair of slit-forming edges 52b through the drawing slit 53.

Screw-fastening recesses 52g are open at one end portion and the other end portion of the housing body 52, and screws S can be fastened into the screw-fastening recesses 52g.

The housing body 52 may be, for example, a metal extrusion molded article. The housing body does not necessarily have the above configuration. For example, the housing body may have a rectangular tubular shape.

The side cover 60 is attached to the one end portion of the housing body 52 so as to close the opening at one end of the housing body 52. The side cover 54 is attached to the other end portion of the housing body 52 so as to close the opening at the other end of the housing body 52.

The side cover 60 includes a shaft-side member 62 and an outer cover member 70. A space configured to accommodate the biasing member 38 is formed between the shaft-side member 62 and the outer cover member 70.

More specifically, each of the shaft-side member 62 and the outer cover member 70 is a resin component formed by injection molding.

The shaft-side member 62 includes a base portion 63 and a peripheral wall portion 65. The base portion 63 is an annular plate-shaped member. An opening 63h in which the one end portion of the shaft body 42 can be disposed is formed in the base portion 63.

The peripheral wall portion 65 rises from a peripheral edge of the base portion 63. The biasing member 38 is disposed in a space surrounded by the peripheral wall portion 65 outside the base portion 63 (on the side opposite to the housing body 52). The peripheral wall portion 65 is formed with engagement recesses 65g configured to be engaged with engagement protrusions 79p formed on a peripheral wall portion 79 on the outer cover member 70 side.

Screw-fastening pieces 63P protrude at a position facing the screw-fastening recesses 52g around the base portion 63. A screw hole is formed in each screw-fastening piece 63P. In a state where the base portion 63 is disposed on the one end portion side of the housing body 52, each screw S is inserted into the screw hole of the corresponding screw-fastening piece 63P and fastened into the corresponding screw-fastening recess 52g, thereby attaching the base portion 63 to the one end portion of the housing body 52.

The fixing configuration of the base portion 63 to the housing body 52 is not limited to the above example. For example, the side cover may be attached to the housing body by a caulking structure or an adhesive.

The outer cover member 70 includes the locking side wall 71 and the peripheral wall portion 79. The locking side wall 71 is an annular plate-shaped member. The locking side wall 71 is formed with the through hole 71h through which the one end portion of the winding shaft 40 can be rotatably disposed.

The peripheral wall portion 79 rises from a peripheral edge of the locking side wall 71. The biasing member 38 is disposed inside the locking side wall 71 (on the housing body 52 side) and in a space surrounded by the peripheral wall portion 79.

The peripheral wall portion 79 is formed as an annular peripheral wall that can be disposed inside the peripheral wall portion 65. The engagement protrusions 79p are formed on an outer surface of the peripheral wall portion 79. The shaft-side member 62 and the outer cover member 70 are combined such that the peripheral wall portion 79 is disposed inside the peripheral wall portion 65. In this state, the engagement protrusions 79p are engaged with the engagement recesses 65g, and the combined state of the shaft-side member 62 and the outer cover member 70 is maintained.

The side cover 54 includes a side wall portion 55 and a support shaft 56.

The side wall portion 55 is an annular plate-shaped member. The support shaft 56 protrudes from the center of the side wall portion 55. The support shaft 56 is formed in an elongated shape, here, a round rod shape, that can be inserted into the bearing hole of the terminal member 48.

Screw-fastening pieces 55P protrude at a position facing the screw-fastening recesses 52g around the side wall portion 55. A screw hole is formed in each screw-fastening piece 55P. In a state where the side wall portion 55 is disposed on the other end portion side of the housing body 52, each screw S is inserted into the screw hole of the corresponding screw-fastening piece 55P and fastened into the corresponding screw-fastening recess 52g, thereby attaching the side cover 54 to the other end portion of the housing body 52.

The winding shaft 40 is rotatably supported by the housing 50 as follows.

That is, the shaft body 42 of the winding shaft 40 is disposed in the housing body 52. The insertion portion 45a of the terminal member 44 is inserted into the one end portion of the shaft body 42, and the flange portion 45b is disposed outside the base portion 63 of the shaft-side member 62. The outer shaft portion 46 protruding from the flange portion 45b is rotatably inserted into the through hole 71h of the locking side wall 71 through the space between the shaft-side member 62 and the outer cover member 70. The distal end of the outer shaft portion 46 is formed in a columnar shape, and the through hole 71h is also formed into a round hole. The distal end of the outer shaft portion 46 of the shaft body 42 is rotatably supported by the through hole 71h, such that the one end portion of the winding shaft 40 is rotatably supported by the housing 50.

In this state, the rotation restricting protrusion 47 protrudes outward from the locking side wall 71. Therefore, the outer shaft portion 46 and the rotation restricting protrusion 47, which are the one end portion of the winding shaft 40, pass through the through hole 71h.

The biasing member 38 is configured to bias the winding shaft 40 in a direction in which the sheet-shaped member 22 is wound. Here, the biasing member 38 is a flat spiral spring. The biasing member 38 is disposed in the space between the shaft-side member 62 and the outer cover member 70. An inner peripheral side end portion of the biasing member 38 is fixed to the outer shaft portion 46 of the terminal member 44 in a state where rotation thereof is prevented. An outer peripheral side end portion of the biasing member 38 is fixed to the peripheral wall portion 79 of the outer cover member 70 in a state where rotation thereof is prevented.

The biasing member 38 is disposed in the side cover 60 in a wound state so as to reduce an outer diameter thereof. The winding shaft 40 is biased in the winding direction by an elastic force of the biasing member 38 to return to the original shape.

Preferably, in a state where the sheet-shaped member 22 is completely wound around the winding shaft 40, the biasing member 38 is wound such that the outer diameter is smaller than the initial outer diameter. Accordingly, even in a state where the sheet-shaped member 22 is completely wound around the winding shaft 40, the biasing member 38 biases the winding shaft 40 in the winding direction.

As the sheet-shaped member 22 is drawn out from this state, the biasing member 38 is wound to become even smaller. In a state where the sheet-shaped member 22 is drawn out, the drawing member 18 or the like is used to maintain the drawn-out state of the sheet-shaped member 22. In this state, since the winding shaft 40 is biased in the winding direction, the sheet-shaped member 22 is maintained in a deployed state.

As the drawn-out state of the sheet-shaped member 22 is released, the winding shaft 40 rotates in the winding direction by a biasing force of the biasing member 38. Accordingly, the sheet-shaped member 22 is wound by the winding shaft 40. As the sheet-shaped member 22 is completely wound, the drawing member 18 comes into contact with a peripheral edge of the drawing slit 53. Accordingly, the other end portion of the sheet-shaped member 22 is prevented from entering the housing 50. Even in this state, the winding shaft 40 is biased in the winding direction. Therefore, the drawing member 18 is pressed against the peripheral edge of the drawing slit 53, preventing the sheet-shaped member 22 from being unintentionally drawn out.

In addition, the biasing member 38 does not necessarily have to be a flat spiral spring. The biasing member 38 may be a torsion coil spring. In this case, the torsion coil spring may be incorporated in the winding shaft, with one end portion connected to the winding shaft in a state in which rotation thereof is prevented, and the other end portion connected to the shaft on the housing side in a state in which rotation thereof is prevented.

It may be required that the winding shaft 40 does not rotate with respect to the housing 50. For example, before the winding device 20 is incorporated into an automobile, to maintain a state in which a predetermined initial biasing force is generated by the biasing member 38, it may be required that the winding shaft 40 does not rotate with respect to the housing 50. For example, for the convenience of maintenance or the like, it may be required that the winding shaft 40 does not rotate with respect to the housing 50 even when the winding device 20 is temporarily removed from the automobile.

The rotation of the winding shaft 40 with respect to the housing 50 is restricted by the lock member 80. The lock member 80 is disposed on an outer surface side of the locking side wall 71 so as to be moved between a lock position and an unlock position. In a state where the lock member 80 is in the lock position, the lock member 80 prevents the rotation of the one end portion of the winding shaft 40 protruding from the through hole 71h. In a state where the lock member 80 is in the unlock position, the lock member 80 allows the rotation of the one end portion of the winding shaft 40. The outer surface side of the locking side wall 71 is an example of a lock member disposition surface. That is, in the present embodiment, an example will be described in which the lock member disposition surface is an outer side surface of the winding shaft 40 facing outward in a longitudinal direction.

### Configuration for Restricting Rotation

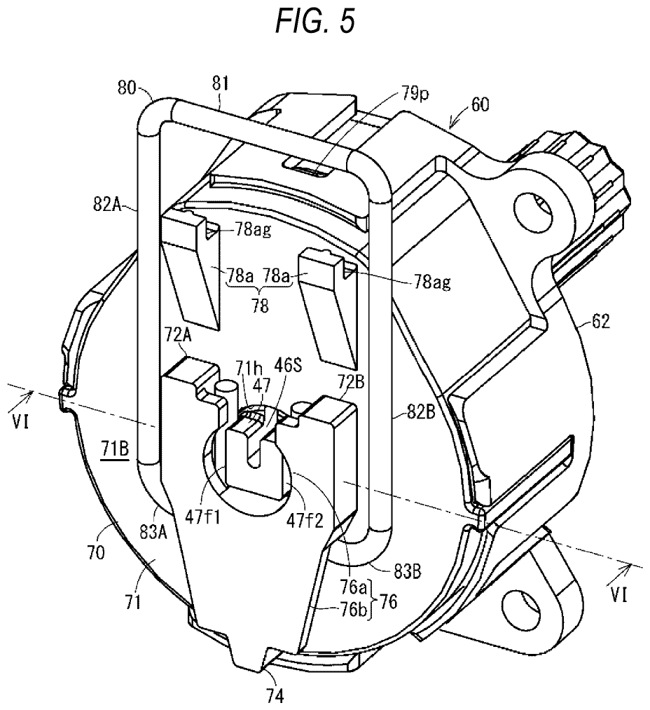

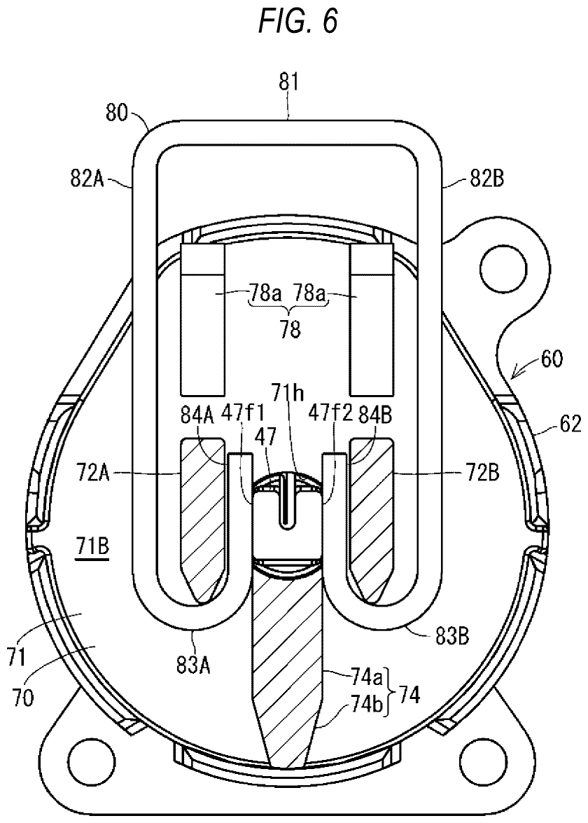

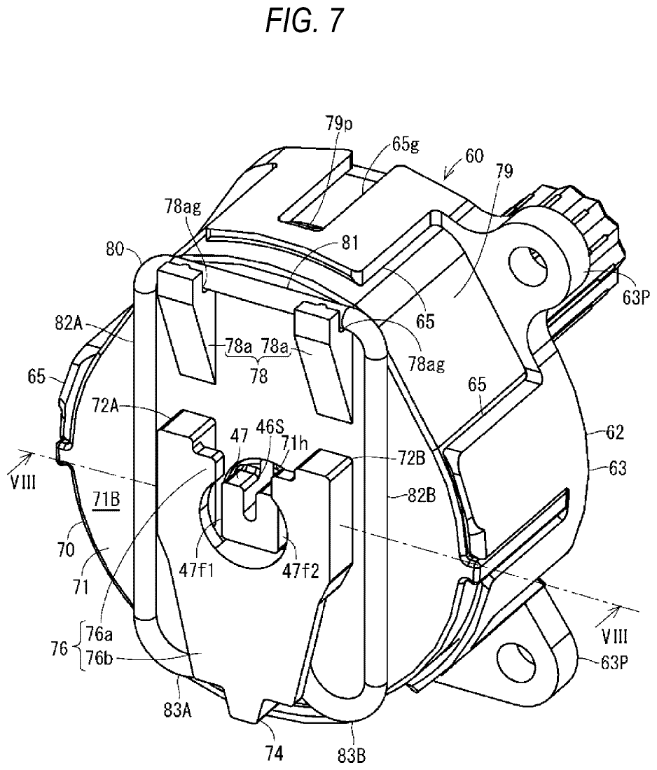

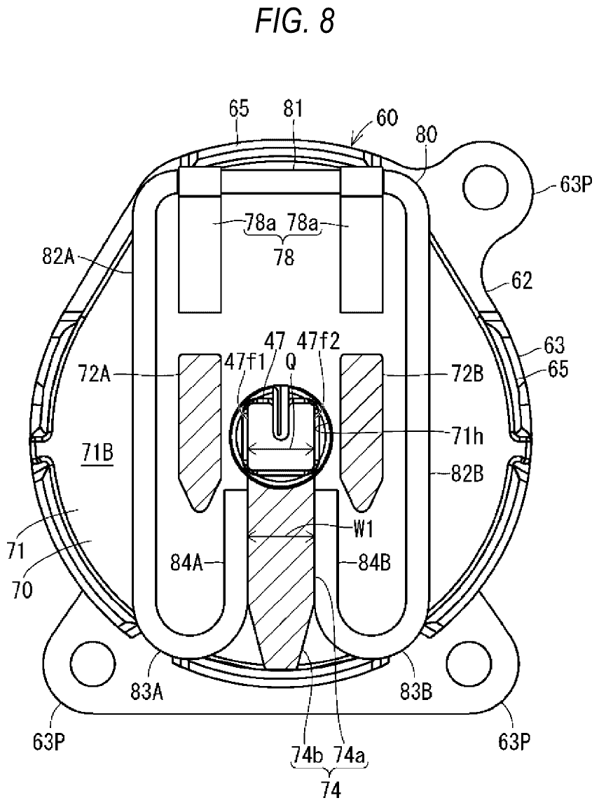

A configuration in which the lock member 80 restricts the rotation of the winding shaft 40 will be described more specifically. FIG. 5 is a perspective view illustrating one end portion of the winding device 20, and FIG. 6 is a cross-sectional view taken along line VI-VI of FIG. 5. FIG. 7 is a perspective view illustrating the one end portion of the winding device 20, and FIG. 8 is a cross-sectional view taken along line VIII-VIII of FIG. 7. FIGS. 5 and 6 illustrate a state in which the lock member 80 is in the lock position, and FIGS. 7 and 8 illustrate a state in which the lock member 80 is in the unlock position. In FIGS. 5 and 7, the terminal member 44, the side cover 60, and the lock member 80 are illustrated, and other members are omitted.

As illustrated in FIGS. 4 to 8, the rotation restricting protrusion 47 at the end portion of the winding shaft 40 protrudes from the through hole 71h. The rotation restricting protrusion 47 is a portion whose rotation is restricted by the lock member 80. The rotation restricting protrusion 47 is an example of a rotation restricting portion whose rotation is restricted by the lock member 80. That is, in the present embodiment, an example will be described in which the rotation restricting portion is a protruding end portion protruding outward in the longitudinal direction of the winding shaft 40 from the through hole 71h. If, as in the present embodiment, the lock member disposition surface is an outer side surface facing outward in the longitudinal direction of the winding shaft 40, and the rotation restricting portion is a protruding end portion protruding from the through hole 71h, it is easy to move the lock member 80. The rotation restricting protrusion 47 includes a first surface 47f1 and a second surface 47f2 that are parallel to each other and face sides opposite to each other. In the present embodiment, the rotation restricting protrusion 47 is surrounded by four side surfaces when viewed along an axial direction of the winding shaft 40. Adjacent side surfaces form a right angle with each other. There are two combinations of two side surfaces facing each other at opposite sides, and a distance between two side surfaces is constant in each combination. That is, the rotation restricting protrusion 47 is formed in a square prism shape. In any combination of the two combinations of side surfaces of the rotation restricting protrusion 47, any one surface can be the first surface 47f1, and any other surface can be the second surface 47f2.

In addition, corner portions of the rotation restricting protrusion 47 may be chamfered or rounded. A slit 46S may be formed from the rotation restricting protrusion 47 toward the outer shaft portion 46. The slit 46S is a slit through which the inner peripheral side end portion of the biasing member 38 is inserted to prevent the inner peripheral side end portion of the biasing member 38 from rotating with respect to the outer shaft portion 46.

It is not essential that the rotation restricting protrusion 47 is formed in a square prism shape. The rotation restricting protrusion 47 may have any shape having two surfaces face each other at opposite sides. For example, the rotation restricting protrusion 47 may be formed in a rectangular prism shape or a plate shape. The rotation restricting protrusion 47 may be formed in a shape obtained by cutting two facing portions of a cylinder with a plane.

The lock member 80 is made of metal or resin. In the present embodiment, it is described on the assumption that the lock member 80 is made of metal. The lock member 80 is preferably made of an elastic material.

The lock member 80 includes an operating portion 81, a first intermediate portion 82A, a second intermediate portion 82B, a first folded portion 83A, a second folded portion 83B, a first lock portion 84A, and a second lock portion 84B.

The operating portion 81 is a portion where an operator applies an operating force with a finger or the like when moving the lock member 80 between the lock position and the unlock position. In the present embodiment, the operating portion 81 includes a linearly extending portion.

The first intermediate portion 82A and the second intermediate portion 82B extend in the same direction from the operating portion 81 in parallel with an interval therebetween. In the present embodiment, the first intermediate portion 82A extends from one end of the operating portion 81, and the second intermediate portion 82B extends from the other end of the operating portion 81. The first intermediate portion 82A and the second intermediate portion 82B extend in parallel along a direction orthogonal to the operating portion 81.

The first folded portion 83A is a portion folded from a distal end of the first intermediate portion 82A, passes through the second intermediate portion 82B side, and folded toward a proximal end side of the first intermediate portion 82A. The second folded portion 83B is a portion folded from a distal end of the second intermediate portion 82B, passes through the first intermediate portion 82A side, and folded toward a proximal end side of the second intermediate portion 82B. In the present embodiment, the first folded portion 83A and the second folded portion 83B are folded in a semicircular arc shape. The first folded portion 83A and the second folded portion 83B are directed in a direction toward each other. However, there is a gap between the first folded portion 83A and the second folded portion 83B.

The folded shapes of the first folded portion and the second folded portion are not particularly limited, and may be, for example, V-shaped or folded at two right-angled positions.

A first lock portion 84A extends from a distal end of the first folded portion 83A along a direction in which the lock member 80 is moved. Here, the first lock portion 84A extends toward the proximal end side of the first intermediate portion 82A along a direction in which the first intermediate portion 82A extends. A second lock portion 84B extends from the distal end of the second folded portion 83B along the direction in which the lock member 80 is moved. In the present embodiment, the second lock portion 84B extends toward the proximal end side of the second intermediate portion 82B along an extending direction of the second intermediate portion 82B.

There is a gap between the first lock portion 84A and the second lock portion 84B. Distal ends of the first lock portion 84A and the second lock portion 84B are located away from the operating portion 81.

The rotation restricting protrusion 47 can be disposed between the first lock portion 84A and the second lock portion 84B. In a state where the rotation restricting protrusion 47 is sandwiched between the first lock portion 84A and the second lock portion 84B, the first lock portion 84A and the second lock portion 84B are pressed against the first surface 47f1 and the second surface 47f2, respectively. Accordingly, the rotation of the rotation restricting protrusion 47 is restricted. In the present embodiment, the lock position is a position where the rotation restricting protrusion 47 is disposed between the first lock portion 84A and the second lock portion 84B (see FIGS. 5 and 6). The unlock position is a position where the rotation restricting protrusion 47 is disposed outside from between the first lock portion 84A and the second lock portion 84B (see FIGS. 7 and 8).

In an initial state before elastic deformation, an interval W2 between the first lock portion 84A and the second lock portion 84B is preferably smaller than a distance Q between the first surface 47f1 and the second surface 47f2. Accordingly, a force to sandwich the rotation restricting protrusion 47 can be generated between the first lock portion 84A and the second lock portion 84B.

The lock member 80 can be easily formed by, for example, bending a metal rod-shaped member, and is preferably formed by bending a spring wire.

The locking side wall 71 includes a wall body 71B, and a first holding portion 72A and a second holding portion 72B that are disposed with an interval therebetween. The first holding portion 72A and the second holding portion 72B are formed to face each other at positions spaced apart from each other with respect to the through hole 71h. The rotation restricting protrusion 47 protruding from the through hole 71h is disposed between the first holding portion 72A and the second holding portion 72B. In this state, a gap in which the first lock portion 84A can be disposed is formed between the first holding portion 72A and the rotation restricting protrusion 47, and a gap in which the second lock portion 84B can be disposed is formed between the second holding portion 72B and the rotation restricting protrusion 47.

In a state where the first surface 47f1 and the second surface 47f2 are parallel to inward surfaces of the first holding portion 72A and the second holding portion 72B, respectively, a gap into which the first lock portion 84A can be inserted, for example, a gap equal to or greater than a diameter of the first lock portion 84A is formed between the first surface 47f1 and the first holding portion 72A. Similarly, a gap into which the second lock portion 84B can be inserted is formed between the second surface 47f2 and the second holding portion 72B.

The interval between the first holding portion 72A and the second holding portion 72B may be equal to or greater than the sum of the distance Q between the first surface 47f1 and the second surface 47f2 and diameters of the lock portions 84A and 84B. In a case where the interval between the first holding portion 72A and the second holding portion 72B is smaller than the sum of the maximum thickness of the rotation restricting protrusion 47 and the diameters of the lock portions 84A and 84B, the lock portions 84A and 84B are restricted from moving outward by the holding portions 72A and 72B, whereby the rotation of the rotation restricting protrusion 47 can be restricted. The maximum thickness of the rotation restricting protrusion 47 is, for example, a distance between diagonal portions on a diagonal line in the rotation restricting protrusion 47.

More specifically, the first holding portion 72A and the second holding portion 72B are portions protruding from an outer surface of the wall body 71B. The first holding portion 72A and the second holding portion 72B extend in parallel to each other at positions spaced apart on both sides of the through hole 71h. The extending direction of the first holding portion 72A and the second holding portion 72B is along a direction connecting the lock position and the unlock position of the lock member 80, and is along the moving direction of the lock member 80.

Each of the holding portions 72A and 72B preferably has a width equal to or less than an interval between the intermediate portion 82A and the lock portion 84A and between the intermediate portion 82B and the lock portion 84B, respectively. Accordingly, the holding portions 72A and 72B can be disposed between the intermediate portion 82A and the lock portion 84A and between the intermediate portion 82B and the lock portion 84B, respectively.

In a state where the lock member 80 is in the lock position, the first lock portion 84A is disposed between the first surface 47f1 and the first holding portion 72A, and the second lock portion 84B is disposed between the second surface 47f2 and the second holding portion 72B. The folded portions 83A and 83B extend from proximal ends of the lock portions 84A and 84B to outer sides of distal ends of the holding portions 72A and 72B on the folded portion 83A and 83B side and reach the outside of both sides of the holding portions 72A and 72B, respectively. The intermediate portions 82A and 82B extend from proximal ends of the folded portions 83A and 83B and past outer sides of the holding portions 72A and 72B, respectively, beyond the rotation restricting protrusion 47 to the outside of the side cover 60. The operating portion 81 connects the proximal ends of the intermediate portions 82A and 82B outside the locking side wall 71.

In a state where the lock member 80 is in the lock position, the first lock portion 84A is disposed between the first surface 47f1 and the first holding portion 72A, and the second lock portion 84B is disposed between the second surface 47f2 and the second holding portion 72B. In this state, the rotation restricting protrusion 47 is rotationally biased by the biasing force of the biasing member 38. Due to this biasing force, the first surface 47f1 and the second surface 47f2 are significantly inclined with respect to the extending direction of the lock portions 84A and 84B, respectively, and push the first lock portion 84A and the second lock portion 84B in directions away from each other. That is, the rotation restricting protrusion 47 is rotationally biased between the lock portions 84A and 84B so as to push the lock portions 84A and 84B apart.

The separated lock portions 84A and 84B are pressed against inward portions of the holding portions 72A and 72B, respectively. The holding portions 72A and 72B restrict the movement of the lock portions 84A and 84B in directions away from each other. Accordingly, the inclination of the first surface 47f1 and the second surface 47f2 is prevented, and the rotation of the rotation restricting protrusion 47 is restricted.

In the rotation restriction state, the first surface 47f1 and the second surface 47f2 are pressed against the lock portions 84A and 84B and the lock portions 84A and 84B are pressed against the holding portions 72A and 72B, respectively, by the biasing force of the biasing member 38, and thus frictional forces act between the first surface 47f1 and the second surface 47f2 and the lock portions 84A and 84B, and further by frictional forces between the lock portions 84A and 84B and the holding portions 72A and 72B. The lock member 80 is maintained in the lock position by these frictional forces.

Preferably, in the extending direction of the holding portions 72A and 72B, the holding portions 72A and 72B have a length that exceeds a diameter of the through hole 71h, and both end portions of each of the holding portions 72A and 72B extend beyond the range in which the through hole 71h is present. Accordingly, the lock portions 84A and 84B can stably come into contact with the holding portions 72A and 72B, respectively, on both outer sides of the through hole 71h.

It is preferable that inward surfaces of the holding portions 72A and 72B are parallel to each other and extend over a length equal to or greater than the first surface 47f1 and the second surface 47f2. Accordingly, the lock portions 84A and 84B can stably come into contact with the holding portions 72A and 72B, respectively, on both outer sides of the through hole 71h.

The distal ends of the holding portions 72A and 72B may be disposed at positions where the distal ends can respectively come into contact with inner peripheral portions of the folded portions 83A and 83B in a state where the lock member 80 is in the lock position. Accordingly, it is easy to set the lock position to be constant.

The distal ends of the holding portions 72A and 72B may be formed so as to be gradually narrowed toward the distal end. By narrowing the distal ends of the holding portions 72A and 72B, the distal ends of the holding portions 72A and 72B can easily come into contact with the folded portions 83A and 83B at stable positions. Inner inclined surfaces of the holding portions 72A and 72B make it difficult for the distal ends of the lock portions 84A and 84B to interfere with the holding portions 72A and 72B, respectively.

When the lock member 80 is in the unlock position, the lock portions 84A and 84B are located away from the rotation restricting protrusion 47 on the side opposite to the operating portion 81, and the rotation restricting protrusion 47 is removed from between the lock portions 84A and 84B. In this state, the folded portions 83A and 83B are separated from the distal ends of the holding portions 72A and 72B. The operating portion 81 approaches the rotation restricting protrusion 47. When viewed along the axial direction of the winding shaft 40, the lock member 80 is accommodated within an outer edge of the side cover 60.

In this state, the lock portions 84A and 84B are separated from the rotation restricting protrusion 47, and thus the rotation restricting protrusion 47 can freely rotate between the holding portions 72A and 72B without being restricted from rotating by the lock member 80.

The locking side wall 71 includes a guide portion 74. The guide portion 74 is a portion protruding from the outer surface of the wall body 71B, and includes a guide body 74a and a widening guide end portion 74b.

The guide portion 74 is located on the gap side with the lock portions 84A and 84B of the lock member 80 at the unlock position with respect to the rotation restricting protrusion 47. Here, the guide portion 74 is located between the lock portions 84A and 84B of the lock member 80 at the unlock position. The guide portion may be located between the rotation restricting protrusion and the gap between the pair of lock portions of the lock member at the unlock position.

The guide portion 74 is formed in an elongated shape along the moving direction of the lock member 80 between the lock position and the unlock position. In the guide portion 74, the guide body 74a is located on the rotation restricting protrusion 47 side, and the widening guide end portion 74b is located on the side far from the rotation restricting protrusion 47.

The guide body 74a has a width W1 equal to or greater than the distance Q between the first surface 47f1 and the second surface 47f2. Preferably, the width of the guide body 74a is equal to the distance Q between the first surface 47f1 and the second surface 47f2. Here, in a case where the width of the guide body 74a is the same as the distance Q between the first surface 47f1 and the second surface 47f2, this includes a case where the width W1 of the guide body 74a is the same as the distance Q between the first surface 47f1 and the second surface 47f2 within a tolerance range. The tolerance range is set, for example, such that the width W1 of the guide body 74a is within a range of +0.1 mm with respect to the distance Q between the first surface 47f1 and the second surface 47f2.

In the present embodiment, the guide body 74a has an elongated shape with a continuous portion of the same width, but the width may change midway.

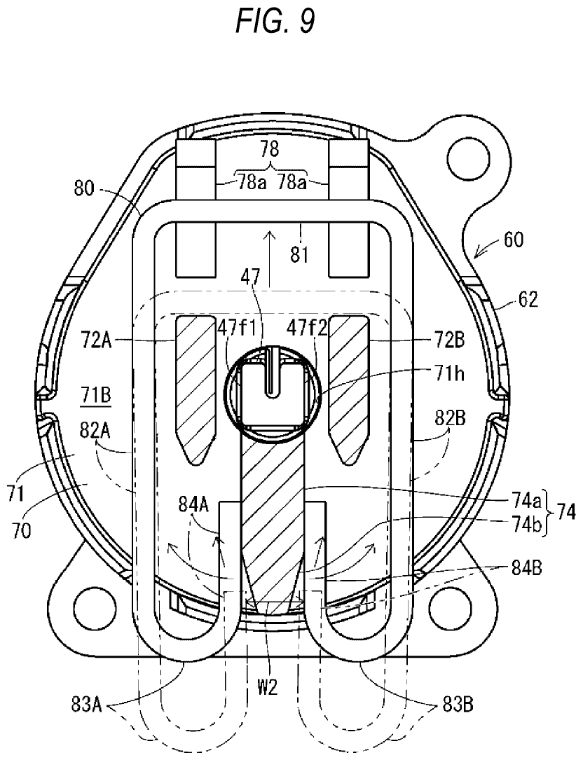

In addition, the interval W2 (see FIG. 9) between the first lock portion 84A and the second lock portion 84B in the initial state in which the lock member 80 is not elastically deformed is preferably smaller than the width W1 of the guide body 74a. Accordingly, in a state where the lock member 80 is in the unlock position, the first lock portion 84A and the second lock portion 84B can sandwich the guide body 74a.

In a state where the lock member 80 is in the unlock position, the lock portions 84A and 84B are disposed on both outer sides of the guide body 74a. Accordingly, the lock portions 84A and 84B are maintained separated by a distance equal to or greater than the distance Q between the first surface 47f1 and the second surface 47f2. As described above, the lock portions 84A and 84B are separated, and thus, in a case where the lock member 80 is moved from the unlock position to the lock position, the lock portions 84A and 84B can be smoothly disposed on both outer sides of the rotation restricting protrusion 47.

The widening guide end portion 74b is located on a side opposite to the rotation restricting protrusion 47 with respect to the guide body 74a. The widening guide end portion 74b is formed in a shape in which the width gradually increases from the minimum width to the maximum width toward the rotation restricting protrusion 47. A distal end of the widening guide end portion 74b is a portion having the minimum width. The minimum width is a width smaller than the interval W2 between the first lock portion 84A and the second lock portion 84B in the initial state in which the lock member 80 is not elastically deformed. The maximum width is the width of the guide body 74a and is a width equal to or greater than the distance Q between the first surface 47f1 and the second surface 47f2.

In a case where the lock member 80 is attached to the locking side wall 71, the lock portions 84A and 84B are disposed on both outer sides of the guide portion 74 along an extending direction of the guide portion 74 from the outside of the locking side wall 71. At this time, the lock portions 84A and 84B come into contact with both side surfaces of the widening guide end portion 74b and are pressed and separated. Therefore, the lock portions 84A and 84B are disposed on both outer sides of the guide body 74a in a state where the interval therebetween is greater than the initial gap W2.

In the present embodiment, the locking side wall 71 has a restricting wall 76 that covers a space between the holding portions 72A and 72B and both outer side spaces of the guide portion 74 at a position away from an outward surface of the wall body 71B. The restricting wall 76 is disposed at a position spaced apart from the outward surface of the wall body 71B by a gap that allows the lock portions 84A and 84B to be disposed therein. The restricting wall 76 includes a first region 76a that closes the space between the holding portions 72A and 72B and a second region 76b that extends from the first region 76a toward the guide portion 74.

The first region 76a has a portion extending from the distal ends of the holding portions 72A and 72B toward the middle thereof. The lock portions 84A and 84B of the lock member 80 at the lock position are disposed between the outward surface of the wall body 71B and the first region 76a of the restricting wall 76 inside the holding portions 72A and 72B.

An opening is formed in the first region 76a on an axial extension of the rotation restricting protrusion 47, and the state of the rotation restricting protrusion 47 can be observed through the opening. Therefore, the lock portions 84A and 84B of the lock member 80 can be easily inserted between the rotation restricting protrusion 47 and the holding portions 72A and 72B while checking the state of the rotation restricting protrusion 47 through the opening. The winding shaft 40 can be rotated using the opening. The restricting wall 76 may be omitted. In this case, the locking side wall may have an eave-shaped portion or a groove-shaped portion that guides the lock member along the wall body.

The second region 76b is formed in a plate shape that extends along the guide portion 74 and gradually narrowed as moving away from the rotation restricting protrusion 47. The second region 76b includes a plate-shaped portion extending outward from a distal end of the guide portion 74 at a position away from an outer surface of the restricting wall 76. The lock portions 84A and 84B of the lock member 80 at the lock position are disposed between the outward surface of the wall body 71B and the second region 76b of the restricting wall 76 on both outer sides of the distal end of the guide portion 74.

The locking side wall 71 includes a receiving portion 78 configured to receive the operating portion 81. The receiving portion 78 is a portion protruding from the outward surface of the wall body 71B. The receiving portion 78 is formed between the intermediate portions 82A and 82B and at a position where the receiving portion 78 receives the operating portion 81 in a state where the lock member 80 is in the unlock position. That is, in a state where the lock member 80 is in the unlock position, the receiving portion 78 is located inside the operating portion 81 and receives the operating portion 81. In a state where the lock member 80 is in the lock position, the operating portion 81 is disposed at a position separated outward from the receiving portion 78.

In the present embodiment, the receiving portion 78 includes a pair of divided receiving portions 78a separated along an extending direction of the operating portion 81. The receiving portion 78 may be one protruding portion.

A recess 78ag into which the operating portion 81 can be fitted is formed in a portion of each divided receiving portion 78a opposite to the rotation restricting protrusion 47. Preferably, the recess 78ag has a width that allows the operating portion 81 to be press-fitted therein. In a state where the lock member 80 is in the unlock position, the operating portion 81 is fitted into the recess 78ag of the receiving portion 78. Accordingly, the lock member 80 is prevented from falling off from the unlock position.

Moreover, in this state, the lock portions 84A and 84B are disposed between the wall body 71B and the restricting wall 76, and thus the lock portions 84A and 84B are less likely to be significantly inclined with respect to the outward surface of the wall body 71B.

This makes it difficult for the operating portion 81 to move in a direction away from the outward surface of the wall body 71B. Therefore, the operating portion 81 is less likely to come off the recess 78ag.

The recess 78ag is located away from the outward surface of the wall body 71B, and preferably receives the operating portion 81 at a position away from the outward surface of the wall body 71B. As described above, the lock portions 84A and 84B are sandwiched between the outward surface of the wall body 71B and the restricting wall 76 and are held along the outward surface of the wall body 71B. In a state where the lock member 80 is in the unlock position and the operating portion 81 is fitted into the recess 78ag at the position away from the outward surface of the wall body 71B, the folded portions 83A and 83B and the intermediate portions 82A and 82B are elastically deformed so as to gradually separate from the outward surface of the wall body 71B toward the operating portion 81. Therefore, the operating portion 81 is pressed against the recess 78ag by an elastic restoring force of the operating portion 81 to return to the state of being along the outward surface of the wall body 71B, and a backlash of the lock member 80 is prevented. The lock member 80 can be easily maintained in the unlock position.

The divided receiving portion 78a is formed such that a dimension of protrusion with respect to the wall body 71B gradually increases as moving away from the rotation restricting protrusion 47. Therefore, in a case where the lock member 80 is attached to the locking side wall 71, if the operating portion 81 is moved in a direction away from the rotation restricting protrusion 47 outside the divided receiving portion 78a, the operating portion 81 can easily ride over the divided receiving portion 78a. Accordingly, the operating portion 81 can be easily fitted into the recess 78ag.

An assembly procedure of the lock member 80 will be described.

In a state where the lock member 80 is disposed along the outer surface of the wall body 71B as in the lock member 80 indicated by a two-dot chain line in FIG. 9, the distal ends of the lock portions 84A and 84B are disposed on both outer sides of the distal end of the guide portion 74, and the operating portion 81 is disposed on the side opposite to the guide portion 74 with respect to the holding portions 72A and 72B.

In this state, by operating the operating portion 81, the lock portions 84A and 84B are inserted between the outer surface of the wall body 71B and the restricting wall 76 and are pushed toward both outer sides of the guide portion 74.

The initial interval W2 between the lock portions 84A and 84B is smaller than the width W1 of the guide body 74a. Therefore, after the lock portions 84A and 84B come into contact with the widening guide end portion 74b and are pushed apart, the lock portions 84A and 84B are disposed on both outer surface sides of the guide body 74a (see the lock member 80 indicated by a solid line in FIG. 9).

The operating portion 81 is operated such that the operating portion 81 further moves in a direction away from the rotation restricting protrusion 47. Then, the lock portions 84A and 84B located on both outer surface sides of the guide body 74a move toward both outer sides of the rotation restricting protrusion 47 while being guided by both outer surfaces of the guide body 74a. That is, the first lock portion 84A is inserted between the rotation restricting protrusion 47 and the first holding portion 72A, and the second lock portion 84B is inserted between the rotation restricting protrusion 47 and the second holding portion 72B.

As described above, the rotation restricting protrusion 47 tends to rotate due to the biasing force of the biasing member 38, and thus the first surface 47f1 and the second surface 47f2 push the lock portions 84A and 84B toward the holding portions 72A and 72B, respectively. By restricting the movement of the lock portions 84A and 84B in directions in which the holding portions 72A and 72B are separated from each other, the inclination of the first surface 47f1 and the second surface 47f2 is prevented, and the rotation of the rotation restricting protrusion 47 is restricted (see FIGS. 5 and 6).

In this state, the lock member 80 is maintained in the lock position by the frictional forces between the first surface and second surface 47f1 and 47f2 and the lock portions 84A and 84B, and further by the frictional forces between the lock portions 84A and 84B and the holding portions 72A and 72B.

After the winding shaft 40 is wound in the winding direction, the rotation of the rotation restricting protrusion 47 is restricted by the lock member 80, and thus a pre-wound state can be maintained by the lock member 80.

The winding device 20 is assembled to the automobile 10 in a state in which the rotation of the winding shaft 40 is restricted. Thereafter, the rotation restriction of the winding shaft 40 is released.

That is, the operating portion 81 is pushed toward the rotation restricting protrusion 47 against the above frictional forces. Then, the lock portions 84A and 84B are released from between the rotation restricting protrusion 47 and the holding portions 72A and 72B, respectively, and move to both outer sides of the guide portion 74 (see FIGS. 7 and 8). Accordingly, the lock member 80 is in the unlock position. In this state, the lock portions 84A and 84B, whose initial interval W2 is smaller than the width W1 of the guide body 74a, sandwich the guide body 74a. Therefore, the backlash of the lock member 80 is less likely to occur with respect to the locking side wall 71. The movement of the lock member 80 from the unlock position to the lock position is prevented by the frictional forces due to the sandwiching.

When the lock member 80 is in the unlock position, the rotation restriction state of the rotation restricting protrusion 47 by the lock portions 84A and 84B is released, and thus the winding shaft 40 can rotate in the housing 50 such that the sheet-shaped member 22 can be drawn out or wound.

When the winding device 20 is removed from the automobile 10 for maintenance or other reasons, the lock member 80 moves from the unlock position to the lock position, thereby maintaining the winding shaft 40 in the rotation restriction state.

### Effects and the Like

According to the winding device 20 for the sheet-shaped member 22 configured as described above, in a state where the lock member 80 is in the lock position, the movement of the first lock portion 84A and the second lock portion 84B in the directions in which the first holding portion 72A and the second holding portion 72B are separated from each other is restricted. Accordingly, the first surface 47f1 and the second surface 47f2 are restricted from being significantly inclined, and the rotation of the rotation restricting protrusion 47 is restricted. In this state, the first lock portion 84A is sandwiched between the first surface 47f1 and the first holding portion 72A, and the first lock portion 84A is sandwiched between the second surface 47f2 and the second holding portion 72B, whereby the lock member 80 is maintained in the lock position.

In a state where the lock member 80 is maintained in the lock position, the first surface 47f1 pushes the first lock portion 84A toward the first holding portion 72A and the second surface 47f2 pushes the second lock portion 84B toward the second holding portion 72B by a rotational biasing force of the biasing member 38. Therefore, the backlash of the lock member 80 is prevented.

To unlock the winding device 20, the operating portion 81 is simply pushed from the lock position toward the unlock position against the frictional force of the first lock portion 84A against the first surface 47f1 and the first holding portion 72A and the frictional force of the second lock portion 84B against the second surface 47f2 and the second holding portion 72B. Therefore, the unlock operation of the winding device 20 can be easily performed.

To move the lock member 80 from the unlock position to the lock position, the operating portion 81 is simply pushed in the opposite direction to that described above. Therefore, a lock operation of the winding device 20 is also easy.

In a state where the lock member 80 is in the lock position, the first holding portion 72A and the second holding portion 72B can come into contact with the first folded portion 83A and the second folded portion 83B, respectively. Therefore, in a case where the lock member 80 is moved to the lock position, the lock member 80 may be moved until the first folded portion 83A and the second folded portion 83B are brought into contact with the first holding portion 72A and the second holding portion 72B, respectively. Therefore, the lock member 80 can be stabilized in the lock position.

The locking side wall 71 includes the receiving portion 78 configured to receive the operating portion 81 of the lock member in the unlock position. Since the receiving portion 78 receives the operating portion 81, the lock member 80 can be easily maintained in the unlock position.

In a case where the lock member 80 is moved to the lock position, the first lock portion 84A and the second lock portion 84B sandwich the guide portion 74, and a width equal to or greater than the distance Q between the first surface 47f1 and the second surface 47f2 is provided between the first lock portion 84A and the second lock portion 84B. Therefore, the first lock portion 84A and the second lock portion 84B are less likely to interfere with the rotation restricting protrusion 47, and are smoothly guided toward both outer sides of the rotation restricting protrusion 47. This makes it easier to lock the winding device 20.

In a case where the interval W2 between the first lock portion 84A and the second lock portion 84B in the initial state of the lock member 80 is smaller than the width W1 of the guide body 74a, in a state where the lock member 80 is in the unlock position, the first lock portion 84A and the second lock portion 84B can sandwich the guide portion 74 by the elastic restoring force. This prevents the backlash of the locking member 80 in an unlock state. The lock member 80 can be easily maintained in the unlock position by the frictional force between the first lock portion 84A and the second lock portion 84B with respect to the guide portion 74.

Further, if the guide portion 74 includes the widening guide end portion 74b, the first lock portion 84A and the second lock portion 84B can be easily separated by the widening guide end portion 74b and disposed on both sides of the guide body 74a. Therefore, the lock member 80 can be easily assembled to the locking side wall 71.

In addition, in the present embodiment, an example has been described in which the configurations for restricting rotation such as the lock member 80, the first holding portion 72A, and the second holding portion 72B are left-right symmetrical. However, it is also assumed that the configurations for restricting rotation is left-right asymmetric.

### Second Embodiment

Hereinafter, a sheet-shaped member winding device according to a second embodiment will be described. In the second embodiment, differences from the first embodiment will be mainly described, and components common to those of the first embodiment may be denoted by the same reference numerals and description thereof may be omitted.

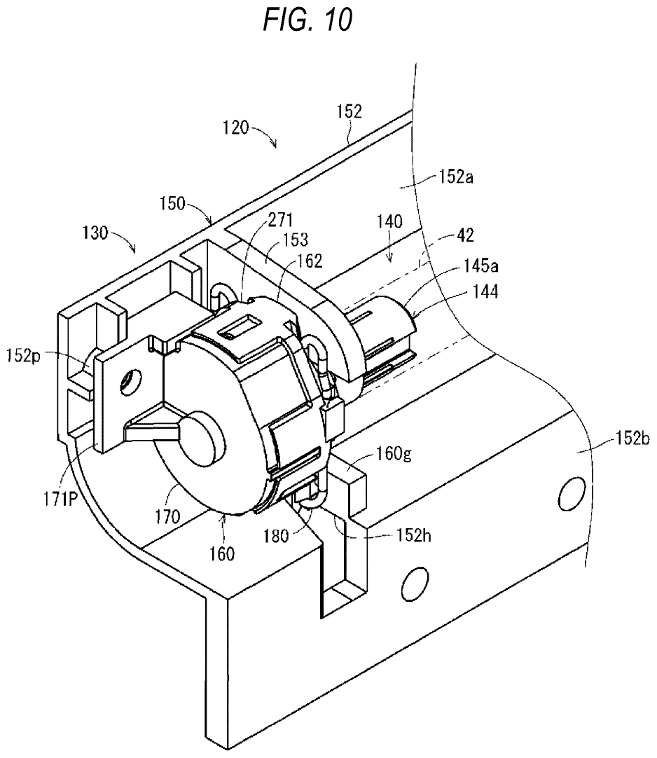

FIG. 10 is a partial perspective view illustrating a sheet-shaped member winding device 120. The sheet-shaped member winding device 120 is a device configured to wind a sheet-shaped member 22 in a drawable manner, similar to the winding device 20.

The sheet-shaped member winding device 120 includes the sheet-shaped member 22 and a winding mechanism 130.

The sheet-shaped member 22 is the same as that described in the first embodiment. One end portion of the sheet-shaped member 22 is inserted into the winding mechanism 130 and attached to a winding shaft 140 in the winding mechanism 130. A rod-shaped drawing member for a drawing operation may be attached to the other end portion of the sheet-shaped member 22 as described in the first embodiment.

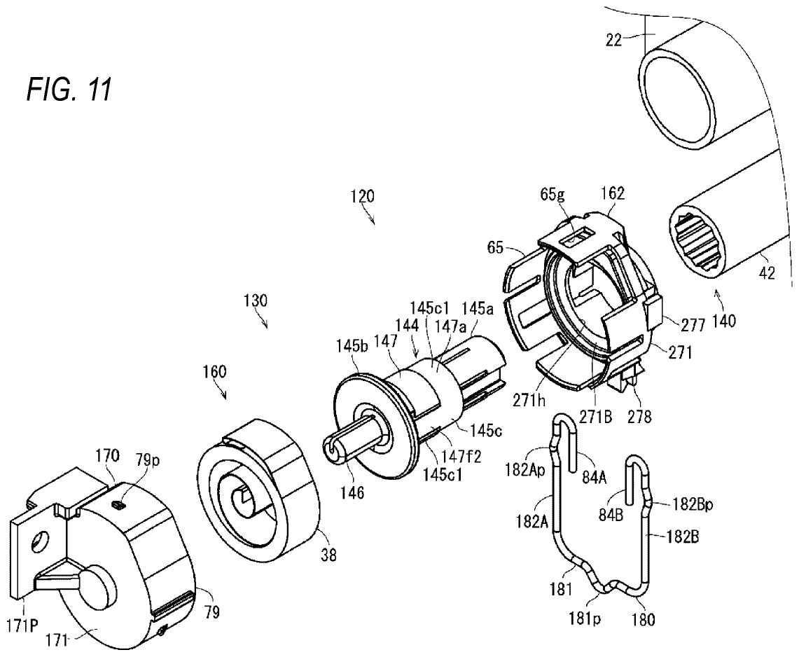

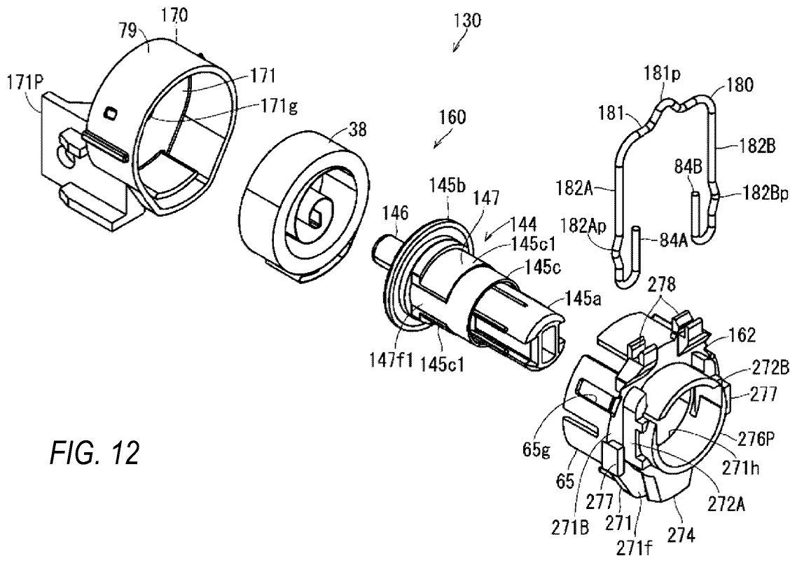

FIGS. 11 and 12 are exploded perspective views of the winding mechanism 130. FIG. 11 is a perspective view of one end portion of the winding mechanism 130 as viewed from the outside of the winding shaft 140, and FIG. 12 is a perspective view of the winding mechanism 130 as viewed from an intermediate side of the winding shaft 140. The top and bottom are also reversed in FIGS. 11 and 12. In addition, although illustrated in FIG. 11, the winding shaft 140 and the sheet-shaped member 22 are omitted in FIG. 12.

As illustrated in FIGS. 10 to 12, the winding mechanism 130 includes the winding shaft 140, a housing 150, a biasing member 38, and a lock member 180.

Similar to the winding shaft 40, the winding shaft 140 is an elongated member having a length equal to or greater than a width of the sheet-shaped member 22. The one end portion of the sheet-shaped member 22 is attached to the winding shaft 140. The sheet-shaped member 22 is wound around the winding shaft 140 or drawn out from the winding shaft 140.

More specifically, the winding shaft 140 includes a shaft body 42, a terminal member 144, and a terminal member.

The shaft body 42 is the shaft body 42 described in the first embodiment. The terminal member 144 is attached to one end portion of the shaft body 42. The terminal member 144 is different from the terminal member 44 described in the first embodiment. The terminal member attached to the other end portion of the shaft body 42 can be the same as the terminal member 48 described in the first embodiment.

The terminal member 144 includes an insertion portion 145a, a flange portion 145b, an intermediate body portion 145c, and an outer shaft portion 146. The terminal member 144 also includes a rotation restricting portion 147. The terminal member 144 is, for example, a resin component formed by injection molding.

The insertion portion 145a is an elongated portion to be inserted into the one end portion of the shaft body 42. The terminal member 144 is attached to the one end portion of the shaft body 42 such that the terminal member 144 is prevented from rotating with respect to the shaft body 42. For example, external teeth formed on an outer periphery of the insertion portion 145a mesh with internal teeth formed on an inner periphery of the shaft body 42, thereby preventing the insertion portion 145a from rotating with respect to the shaft body 42. As described in the first embodiment, the configuration for preventing the rotation of the terminal member 144 with respect to the shaft body 42 is not limited to the above example.

The intermediate body portion 145c is connected to a proximal end side of the insertion portion 145a. The intermediate body portion 145c is thicker than the insertion portion 145a. In a state where the insertion portion 145a is inserted into the one end portion of the shaft body 42, an annular end surface of the intermediate body portion 145c facing the insertion portion 145a abuts against one end surface of the shaft body 42, and the terminal member 144 is located in a longitudinal direction of the shaft body 42.

The flange portion 145b is formed in an annular portion protruding from a proximal end of the intermediate body portion 145c toward an outer peripheral side. The flange portion 145b and the one end surface of the shaft body 42 are separated by a distance corresponding to a length of the intermediate body portion 145c.

The outer shaft portion 146 is an elongated portion protruding to the side opposite to the intermediate body portion 145c and the insertion portion 145a with respect to the flange portion 145b. In a state where the insertion portion 145a is inserted into the one end portion of the shaft body 42, the outer shaft portion 146 extends outward from the one end portion of the shaft body 42. The outer shaft portion 146 is used to bias the shaft body 42 in a winding direction.

The rotation restricting portion 147 is located closer to the shaft body 42 than to the outer shaft portion 146 of the terminal member 144. That is, the rotation restricting portion 147 is located closer to the shaft body 42 than is the flange portion 145b. Here, the intermediate body portion 145c includes the rotation restricting portion 147. The rotation restricting portion 147 is used to restrict the rotation of the shaft body 42. The intermediate body portion 145c and the rotation restricting portion 147 are an example of one end portion of the winding shaft 140.

The housing 150 includes a locking side wall 271 having a through hole 271h, and supports the winding shaft 140 such that the winding shaft 140 can rotate in a state where the end portion of the winding shaft 140 passes through the through hole 271h.

More specifically, the housing 150 includes a housing body 152, a bearing member 160, and a bearing member.

The housing body 152 is formed in a shape that at least partially covers the winding shaft 140 around which the sheet-shaped member 22 is wound.

For example, the housing body 152 includes a partial cylindrical portion 152a and an attachment piece 152b. The partial cylindrical portion 152a is formed in a shape that partially covers the winding shaft 140 around which the sheet-shaped member 22 is wound in a circumferential direction of the winding shaft 140. More specifically, the partial cylindrical portion 152a is formed in a partial cylindrical shape that occupies approximately ¼ to ⅓ in a circumferential direction of a cylinder. The partial cylindrical portion 152a is longer than the shaft body 42 and covers the sheet-shaped member 22 wound around the winding shaft 140 in the entire longitudinal direction of the shaft body 42. The partial cylindrical portion 152a may be longer than the winding shaft 140.

The attachment piece 152b extends from an edge on one side in the circumferential direction of the partial cylindrical portion 152a. Screw holes or the like are formed in the attachment piece 152b, and the housing body 152 is attached to an attachment object via the attachment piece 152b. The attachment object is, for example, a frame portion surrounding a window of an automobile. By attaching the housing body 152 to the frame portion, the sheet-shaped member 22 wound around the winding shaft 140 is surrounded by the housing body 152 and the attachment object. A slit for drawing out the sheet-shaped member 22 is formed between the housing body 152 and the attachment object.

A support wall portion 153 is formed at one end portion of the partial cylindrical portion 152a in a longitudinal direction. The support wall portion 153 is formed in a plate shape extending from an inner peripheral surface of the partial cylindrical portion 152a in a direction orthogonal to the longitudinal direction of the partial cylindrical portion 152a.

A recess 160g into which the bearing member 160 is partially fitted is formed in the support wall portion 153. When the part of the bearing member 160 surrounding the winding shaft 140 is fitted into the recess 160g, the bearing member 160 is located in contact with an outward surface of the support wall portion 153.

A fixing portion 152p is formed at one end portion of the partial cylindrical portion 152a in the longitudinal direction and at a portion outside the support wall portion 153. For example, a screw hole is formed in the fixing portion 152p. The bearing member 160 is fastened and fixed to the fixing portion 152p in a state where the bearing member 160 is located on the support wall portion 153. The fixing structure of the bearing member 160 is not limited to this example. For example, the bearing member 160 may be fixed to the housing body 152 by an adhesive, a fitting structure, thermal welding, or the like.

The support wall portion 153 may be formed inside an opening on one end side in the longitudinal direction of the partial cylindrical portion 152a. In this case, the bearing member 160 can be easily protected in the partial cylindrical portion 152a. The support wall portion 153 may be formed at an edge of the opening on the one end side in the longitudinal direction of the partial cylindrical portion 152a.

An operating opening 152h is formed in a portion of the partial cylindrical portion 152a outside the support wall portion 153. In a state where the bearing member 160 is supported by the housing body 152, an operating portion 181 of the lock member 180 is disposed at a position facing the operating opening 152h. An operator can operate and move the lock member 180 by touching the operating portion 181 through the operating opening 152h.

A bearing member similar to the side cover 54 in the first embodiment may be supported by the other end portion of the partial cylindrical portion 152a in the longitudinal direction, and the other end portion of the winding shaft 140 may be rotatably supported by the same configuration as in the first embodiment.

The housing body 152 may be a component made of resin or a component made of metal. As in the first embodiment, a larger part around the winding shaft 140 may be covered by a tubular member.

One bearing member 160 is attached to one end portion of the housing body 152. The other bearing member is attached to the other end portion of the housing body 152. Since both ends of the winding shaft 140 are rotatably supported by both ends of the housing body 152, the winding shaft 140 rotates inside the housing body 152, and the sheet-shaped member 22 can be wound or drawn out.

The bearing member 160 includes a shaft-side member 162 and an outer cover member 170. A space configured to accommodate the biasing member 38 is formed between the shaft-side member 162 and the outer cover member 170.

More specifically, each of the shaft-side member 162 and the outer cover member 170 is a resin component formed by injection molding.

The shaft-side member 162 includes the locking side wall 271 and a peripheral wall portion 65.

The locking side wall 271 is an annular plate-shaped member and is a portion corresponding to the base portion 63 in the first embodiment. The through hole 271h through which the one end portion of the winding shaft 140 can pass is formed in the locking side wall 271. The through hole 271h is, for example, a circular opening through which the intermediate body portion 145c is rotatably inserted. The through hole 271h is formed to be smaller than the flange portion 145b, and the through hole 271h is closed by the flange portion 145b. Unlike the first embodiment, the locking side wall 271 has a lock member disposition surface 271f on which the lock member 180 is movably disposed. A lock structure by the lock member 180 will be described in detail later.

As described in the first embodiment, the peripheral wall portion 65 rises from a peripheral edge of the locking side wall 271.

The outer cover member 170 includes an outer side wall 171 and a peripheral wall portion 79. The outer side wall 171 is an annular plate-shaped member. Unlike the first embodiment, no lock member is disposed on the outer side wall 171.

Unlike the first embodiment, no through hole is formed in the outer side wall 171. A bearing recess 171g is formed at the center of the outer side wall 171. The bearing recess 171g is a recessed portion when viewed from the inside of the outer side wall 171. A distal end of the outer shaft portion 146 is rotatably inserted into and supported by the bearing recess 171g. The part of the outer side wall 171 where the bearing recess 171g is formed may protrude when viewed from the outside. The outer side wall 171 closes an internal space of the bearing member 160 with respect to an outer space.

As described in the first embodiment, the peripheral wall portion 79 rises from a peripheral edge of the outer side wall 171. The biasing member 38 is disposed inside the outer side wall 171 and in a space surrounded by the peripheral wall portion 79.

The peripheral wall portion 79 is formed as an annular peripheral wall that can be disposed inside the peripheral wall portion 65. As described in the first embodiment, an engagement protrusion 79p on an outer surface of the peripheral wall portion 79 is engaged with a recess 65g of the peripheral wall portion 65, and the combined state of the shaft-side member 162 and the outer cover member 170 is maintained.

In addition, a screw-fastening piece 171P extending outward along an extending direction of the winding shaft 140 protrudes from a part of the periphery of the outer cover member 170. The bearing member 160 is fixed to the inside of the one end portion of the housing body 152 using the screw-fastening piece 171P.

The winding shaft 140 is rotatably supported by the housing 150 as follows.

That is, the shaft body 42 of the winding shaft 140 is disposed in the housing body 152. The insertion portion 145a of the terminal member 144 is inserted into the one end portion of the shaft body 42, the intermediate body portion 145c passes through the through hole 271h, and the flange portion 145b is disposed on the side opposite to the lock member disposition surface 271f with respect to the locking side wall 271. Therefore, the intermediate body portion 145c extends from the flange portion 145b toward the end portion of the shaft body 42 through the through hole 271h.

The outer shaft portion 146 protruding from the flange portion 145b is rotatably inserted into the bearing recess 171g of the outer side wall 171 through a space between the shaft-side member 162 and the outer cover member 170. The distal end of the outer shaft portion 146 is formed in a columnar shape, and the bearing recess 171g is also formed in a bottomed round hole shape. The distal end of the outer shaft portion 146 is rotatably supported by the bearing recess 171g, such that the one end portion of the winding shaft 140 is rotatably supported by the housing 150.

In this state, the intermediate body portion 145c passes through the through hole 271h of the locking side wall 271 and protrudes to an intermediate side in the extending direction of the winding shaft 140.

The biasing member 38 biases the winding shaft 140 in a direction in which the sheet-shaped member 22 is wound. Here, as described in the first embodiment, the biasing member 38 is a flat spiral spring. The biasing member 38 is disposed in the space between the shaft-side member 162 and the outer cover member 170. An inner peripheral side end portion of the biasing member 38 is fixed to the outer shaft portion 146 in a state in which rotation thereof is prevented. An outer peripheral side end portion of the biasing member 38 is fixed to the peripheral wall portion 79 of the outer cover member 170 in a state in which rotation thereof is prevented.

As described in the first embodiment, the winding shaft 140 is biased in the winding direction by the biasing member 38. Therefore, by drawing out the sheet-shaped member 22 against a winding biasing force, the sheet-shaped member 22 can be used as a shading member or a partition member. When the sheet-shaped member 22 is not used as a shading member or a partition member, the sheet-shaped member 22 can be wound around the winding shaft 140 by the winding biasing force.

As described in the first embodiment, it may be required that the winding shaft 140 does not rotate with respect to the housing body 152. Therefore, the rotation of the winding shaft 140 with respect to the housing body 152 is restricted by the lock member 180. Unlike the first embodiment, in the second embodiment, the lock member 180 is disposed on the lock member disposition surface 271f side on the shaft body 42 side in the locking side wall 271 located on the shaft body 42 side, so as to be movable between a lock position and an unlock position. In a state where the lock member 180 is in the lock position, the lock member 180 prevents the rotation of the part of the one end portion of the winding shaft 140 protruding from the through hole 271h toward the shaft body 42. In a state where the lock member 180 is in the unlock position, the lock member 180 allows the rotation of the one end portion of the winding shaft 140.

### Configuration for Restricting Rotation

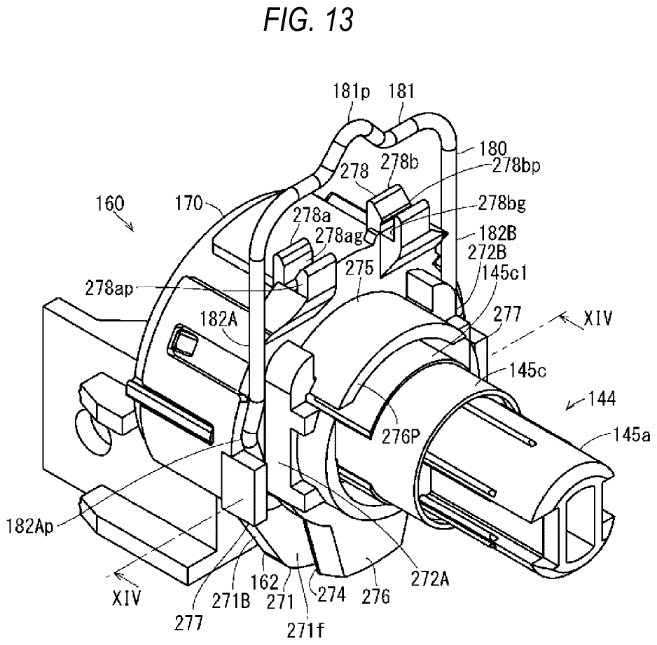

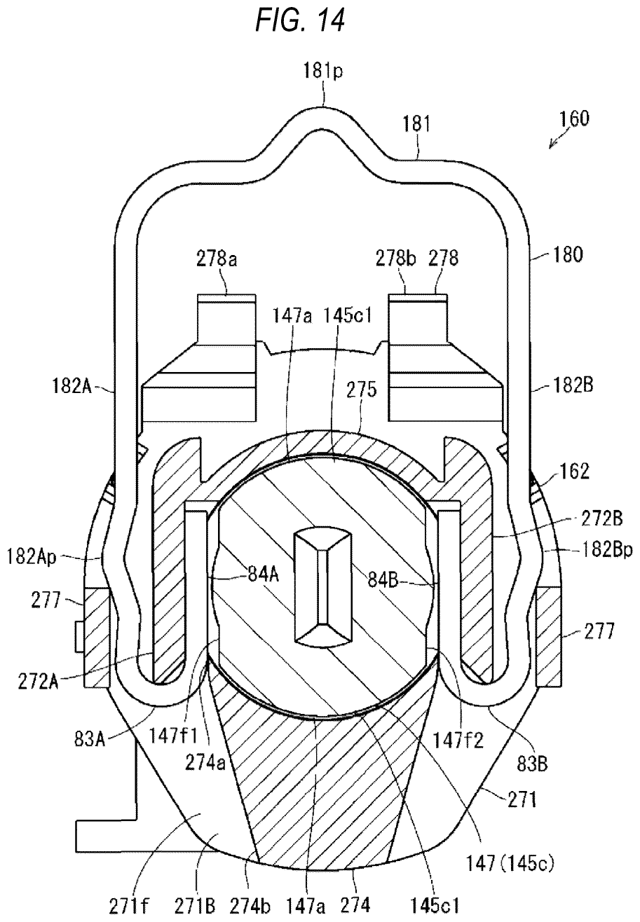

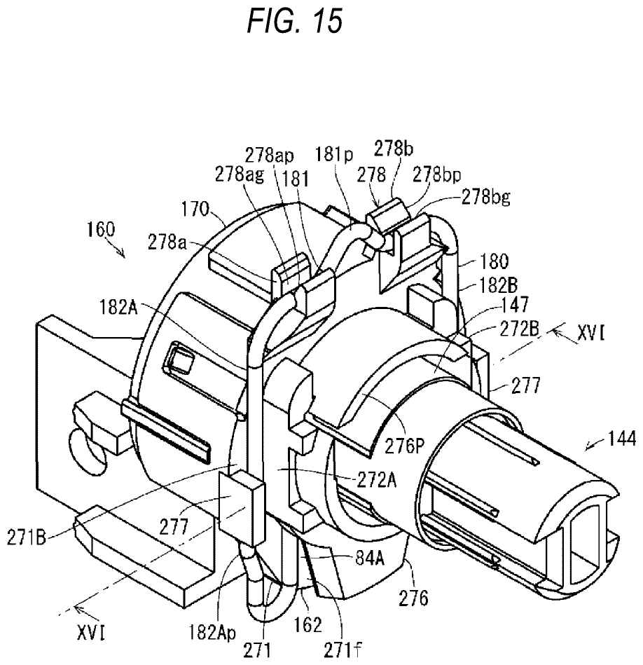

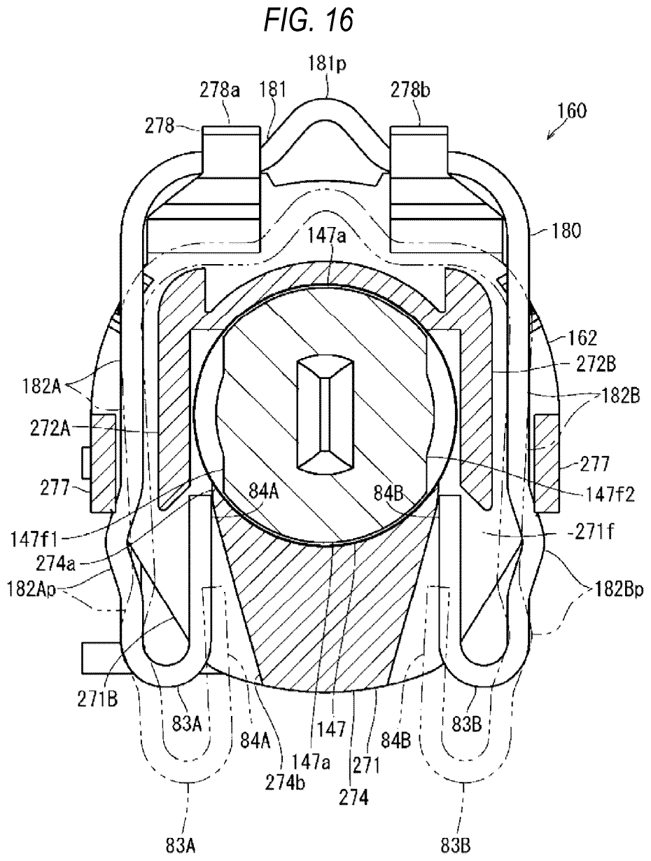

A configuration in which the lock member 180 restricts the rotation of the winding shaft 140 will be described more specifically. FIG. 13 is a perspective view illustrating the bearing member 160, and FIG. 14 is a cross-sectional view taken along line XIV-XIV of FIG. 13. FIG. 15 is a perspective view illustrating the bearing member 160, and FIG. 16 is a cross-sectional view taken along line XVI-XVI of FIG. 15. FIGS. 13 and 14 illustrate a state in which the lock member 180 is in the lock position, and FIGS. 15 and 16 illustrate a state in which the lock member 180 is in the unlock position.

As illustrated in FIGS. 10 to 16, the intermediate body portion 145c at the end portion of the winding shaft 140 extends from the flange portion 145b to an intermediate side in a longitudinal direction of the winding shaft 140 through the through hole 271h. A portion of the intermediate body portion 145c extending from the through hole 271h toward the middle in the longitudinal direction of the winding shaft 140, here, a portion of the intermediate body portion 145c close to the flange portion 145b is the rotation restricting portion 147.

More specifically, a portion of the intermediate body portion 145c close to the insertion portion 145a is formed into a circular outer circumferential surface. A pair of partial protrusions 145cl partially protruding in a circumferential direction are formed on the portion of the intermediate body portion 145c close to the flange portion 145b. The partial protrusions 145c1 form the rotation restricting portion 147 having a non-circular cross section.

More specifically, the rotation restricting portion 147 includes a first surface 147f1 and a second surface 147f2 that are parallel to each other and face each other at opposite sides. In the present embodiment, the rotation restricting portion 147 is surrounded by the first surface 147f1, the second surface 147f2, and two arcuate curved surfaces 147a when viewed along an axial direction of the winding shaft 140.

The first surface 147f1 and the second surface 147f2 are located opposite to each other on an outer periphery of the rotation restricting portion 147. In a circumferential direction of the rotation restricting portion 147, one arcuate curved surface 147a is located between one ends of the first surface 147f1 and the second surface 147f2, and the other arcuate curved surface 147a is located between the other ends of the first surface 147f1 and the second surface 147f2.

The two arcuate curved surfaces 147a are arcuate curved surfaces whose center of curvature is a central axis of the intermediate body portion 145c. For example, the arcuate curved surfaces 147a may have a shape that can be disposed in the through hole 271h and along an edge of the through hole 271h. It is difficult to restrict the rotation of the terminal member 144 even by sandwiching the two arcuate curved surfaces 147a. The first surface 147f1 and the second surface 147f2 are surfaces closer to being flat than the arcuate curved surfaces 147a. Therefore, the rotation of the terminal member 144 can be easily restricted by sandwiching the pair of first surface 147f1 and second surface 147f2.

More specifically, each of the first surface 147f1 and the second surface 147f2 includes a pair of flat surfaces on both end sides in the circumferential direction of the rotation restricting portion 147 and an arcuate curved surface located between the pair of flat surfaces. The pair of flat surfaces of the first surface 147f1 are formed by end surfaces in a circumferential direction of the pair of partial protrusions 145c1, and are located on the same plane. Similarly, the pair of flat surfaces of the second surface 147f2 are formed by end surfaces in the circumferential direction of the pair of partial protrusions 145c1, and are located on the same plane. The flat surfaces of the first surface 147f1 and the flat surfaces of the second surface 147f2 are parallel to each other and face in opposite directions.

The arcuate curved surface located between the pair of flat surfaces is an arcuate curved surface whose center of curvature is the central axis of the intermediate body portion 145c. The arcuate curved surface located between the pair of flat surfaces is located near the central axis of the intermediate body portion 145c than the arcuate curved surface 147a, and is continuous with a circular outer peripheral surface of the portion of the intermediate body portion 145c close to the insertion portion 145a.

That is, each flat surface of the first surface 147f1 and the second surface 147f2 is formed by the end surface in the circumferential direction of the partial protrusion 145c1, and the arcuate curved surface between the pair of flat surfaces has a shape continuous with the circular outer peripheral surface of the portion of the intermediate body portion 145c close to the insertion portion 145a. Accordingly, the first surface 147f1 and the second surface 147f2 for restricting rotation are formed in the intermediate body portion 145c without forming a recess when viewed from the insertion portion 145a side. Therefore, the terminal member 144 can be easily molded using a mold.

As described above, the first surface 147f1 and the second surface 147f2 need only be flat enough to be able to prevent the rotation of the terminal member 144 by being sandwiched from both outer sides, and do not need to be flat surfaces. In addition, the first surface and the second surface may be flat surfaces. The rotation restricting portion may be formed in a shape having a prismatic outer peripheral surface. The rotation restricting portion may be hollow or solid in which the inside is filled.

The rotation restricting portion 147 is located at the end portion of the winding shaft 140 closer to the intermediate side in the longitudinal direction of the winding shaft 140 than is the through hole 271h. The rotation restricting portion 147 is restricted from rotating by the lock member 180 located on the lock member disposition surface 271f side of the locking side wall 271.

The lock member 180 is made of metal or resin, similar to the lock member 80. Here, it is assumed that the lock member 180 is made of metal.

As described above, the lock member 180 is movably disposed on the lock member disposition surface 271f side with respect to the locking side wall 271.

The lock member 180 includes the operating portion 181, a first intermediate portion 182A, a second intermediate portion 182B, a first folded portion 83A, a second folded portion 83B, a first lock portion 84A, and a second lock portion 84B.

The first folded portion 83A, the second folded portion 83B, the first lock portion 84A, and the second lock portion 84B have the same configurations as those described in the first embodiment.

The operating portion 181 is a portion corresponding to the operating portion 81 described in the first embodiment, but the following configurations are added.

That is, similar to the operating portion 81, the operating portion 181 is a portion that receives an operation on the lock member 180. An operating protrusion 181p protruding to the side opposite to the rotation restricting portion 147 is formed at an intermediate portion in an extending direction of the operating portion 181. The operating protrusion 181p is formed, for example, by partially bending a linear part forming the operating portion 181 into a V shape. Both end portions of the operating portion 181 connected to the operating protrusion 181p extend on the same straight line. The operating protrusion 181p can protrude to the side opposite to the rotation restricting portion 147 between a first receiving portion 278a and a second receiving portion 278b to be described later.

The first intermediate portion 182A and the second intermediate portion 182B are portions corresponding to the first intermediate portion 82A and the second intermediate portion 82B described in the embodiment, but the following configurations are added.

That is, similar to the first intermediate portion 82A, the first intermediate portion 182A is a portion interposed between the operating portion 181 and the folded portion 83A. A position restricting engagement portion 182Ap is formed in an intermediate portion in an extending direction of the first intermediate portion 182A. The position restricting engagement portion 182Ap is formed, for example, by partially bending a linear part forming the first intermediate portion 182A into a V shape. Both end portions of the first intermediate portion 182A connected to the position restricting engagement portion 182Ap extend on the same straight line. The position restricting engagement portion 182Ap is bent so as to protrude to the side opposite to the rotation restricting portion 147. Depending on the position of the lock member 180, the position restricting engagement portion 182Ap can be engaged with a position restricting portion 277 to be described later from the operating portion 181 side or from the side opposite to the operating portion 181.

Similarly, the second intermediate portion 182B is also provided with a position restricting engagement portion 182Bp. One or both of the position restricting engagement portions 182Ap and 182Bp may be omitted.

The rotation restricting portion 147 is disposed between the first lock portion 84A and the second lock portion 84B. When the rotation restricting portion 147 is sandwiched between the first lock portion 84A and the second lock portion 84B, the first lock portion 84A and the second lock portion 84B are pressed against the first surface 147f1 and the second surface 147f2, respectively, and thus the rotation of the rotation restricting portion 147 is restricted. Even in a case where the first surface 147f1 and the second surface 147f2 have an arcuate curved surface, the first lock portion 84A and the second lock portion 84B come into contact with an outer flat surface of the arcuate curved surface, and thus the rotation of the rotation restricting portion 147 is restricted.

In the present embodiment, the lock position is a position where the rotation restricting portion 147 is disposed between the first lock portion 84A and the second lock portion 84B (see FIGS. 13 and 14). The unlock position is a position where the rotation restricting portion 147 is disposed outside from between the first lock portion 84A and the second lock portion 84B (see FIGS. 15 and 16).

As described above, the locking side wall 271 is a side wall of the shaft-side member 162, that is, a side wall of the bearing member 160 on the shaft body 42 side. The locking side wall 271 includes a wall body 271B, and a first holding portion 272A and a second holding portion 272B that are disposed with an interval therebetween. A surface of the wall body 271B facing the intermediate side in the longitudinal direction of the winding shaft 140 is the lock member disposition surface 271f.

Similar to the first holding portion 72A and the second holding portion 72B, the first holding portion 272A and the second holding portion 272B are formed to face each other at positions spaced apart from each other with respect to the through hole 271h. The rotation restricting portion 147 protruding from the through hole 271h to the intermediate side in the longitudinal direction of the winding shaft 140 is disposed between the first holding portion 272A and the second holding portion 272B. In this state, a gap in which the first lock portion 84A can be disposed is formed between the first holding portion 272A and the rotation restricting portion 147, and a gap in which the second lock portion 84B can be disposed is formed between the second holding portion 272B and the rotation restricting portion 147.

In a state where the first surface 147f1 and the second surface 147f2 face inward surfaces of the first holding portion 272A and the second holding portion 272B, respectively, a gap into which the first lock portion 84A can be inserted, for example, a gap equal to or greater than a diameter of the first lock portion 84A is formed between the first surface 147f1 and the first holding portion 272A. Similarly, a gap into which the second lock portion 84B can be inserted is formed between the second surface 147f2 and the second holding portion 272B.

Specifically, the first holding portion 272A and the second holding portion 272B are portions that protrude from the lock member disposition surface 271f of the wall body 271B facing the middle in the longitudinal direction of the winding shaft 140. The first holding portion 272A and the second holding portion 272B extend in parallel to each other at outer peripheral side positions of the through hole 271h.

The locking side wall 271 includes a guide portion 274. The guide portion 274 is a portion protruding from an outer surface of the wall body 271B, and includes a guide body 274a and a widening guide end portion 274b.

The guide portion 274 is a portion corresponding to the guide portion 74. The guide body 274a and the widening guide end portion 274b have different sizes from the guide body 74a and the widening guide end portion 74b, respectively, but can play the same role.

The locking side wall 271 includes an arcuate wall 275. The arcuate wall 275 is located on a side of the rotation restricting portion 147 where the operating portion 181 of the lock member 180 is disposed. The arcuate wall 275 extends along an outer side of a peripheral edge of the through hole 271h. The arcuate wall 275 may extend so as to connect end portions of the first holding portion 272A and the second holding portion 272B on the operating portion 181 side. Since the rotation restricting portion 147 is surrounded by the arcuate wall 275, the first holding portion 272A, the second holding portion 272B, and the guide portion 274, foreign matter is less likely to adhere to the rotation restricting portion 147.

In the present embodiment, the locking side wall 271 has a restricting wall 276 that covers a space between the holding portions 272A and 272B and both outer side spaces of the guide portion 274 at a position away from the lock member disposition surface 271f of the wall body 271B. The restricting wall 276 is disposed at a position spaced apart from the lock member disposition surface 271f by a gap that allows the lock portions 84A and 84B to be disposed therein. A cylindrical portion 276P extends from the arcuate wall 275, the restricting wall 276, and the guide portion 274. The cylindrical portion 276P surrounds the portion of the intermediate body portion 145c on the flange portion 145b side at an interval.

The locking side wall 271 includes position restricting portions 277 located adjacent to respective movement paths of the first intermediate portion 182A and the second intermediate portion 182B. In addition, the position restricting portion 277 may be located only adjacent to the movement path of the first intermediate portion 182A or the second intermediate portion 182B. In the present embodiment, the position restricting portions 277 are located outside and adjacent to the respective movement paths of the first intermediate portion 182A and the second intermediate portion 182B, but the position restricting portion may be located inside and adjacent to the movement path of the first intermediate portion or the second intermediate portion. For example, an outward portion of the first holding portion or the second holding portion may be the position restricting portion.

The position restricting portion 277 is located outward away from the first holding portion 272A (or the second holding portion 272B). A gap that allows the first intermediate portion 182A (or the second intermediate portion 182B) to pass therethrough and allows the first intermediate portion 182A (or the second intermediate portion 182B) to be elastically displaced inward is formed between the position restricting portion 277 and the first holding portion 272A (or the second holding portion 272B).

The position restricting portion 277 is disposed at a position overlapping the rotation restricting portion 147 and the first holding portion 272A (or the second holding portion 272B) in a moving direction of the lock member 180.

In a state where the lock member 180 is in the lock position, the position restricting engagement portion 182Ap (or the position restricting engagement portion 182Bp) of the first intermediate portion 182A (or the second intermediate portion 182B) comes into contact with and locks the position restricting portion 277 from the operating portion 181 side. This prevents the lock member 180 from moving to the side opposite to the operating portion 181, that is, the unlock position. In a state where the lock member 180 is in the unlock position, the position restricting engagement portion 182Ap (or the position restricting engagement portion 182Bp) of the first intermediate portion 182A (or the second intermediate portion 182B) comes into contact with and locks the position restricting portion 277 from the side opposite to the operating portion 181. This prevents the lock member 180 from moving to the operating portion 181 side, that is, the lock position.

In a case where the lock member 180 is moved from the lock position to the unlock position, the operating portion 181 is pushed firmly toward the rotation restricting portion 147 to move the first intermediate portion 182A (or the second intermediate portion 182B) toward the first folded portion 83A (or the second folded portion 83B). Then, the position restricting engagement portion 182Ap (or the position restricting engagement portion 182Bp) is pressed against the position restricting portion 277. Accordingly, the first intermediate portion 182A (or the second intermediate portion 182B) is elastically displaced inward, and the position restricting engagement portion 182Ap (or the position restricting engagement portion 182Bp) can pass over the position restricting portion 277.

As the lock member 180 further moves to the unlock position side, the position restricting engagement portion 182Ap (or the position restricting engagement portion 182Bp) passes over the position restricting portion 277. Then, the first intermediate portion 182A (or the second intermediate portion 182B) is displaced to the position restricting portion 277 side by an elastic restoring force of the lock member 180, and the position restricting engagement portion 182Ap (or the position restricting engagement portion 182Bp) is engaged with the position restricting portion 277 from the folded portions 83A and 83B side. Accordingly, the lock member 180 is maintained in the unlock position.

In a case where the lock member 180 is moved from the unlock position to the lock position, if the operating portion 181 is pulled firmly in a direction away from the rotation restricting portion 147, the position restricting engagement portion 182Ap (or the position restricting engagement portion 182Bp) can pass over the position restricting portion 277 while elastically deforming the lock member 180 as described above.

Therefore, in a normal state, the position restricting engagement portion 182Ap (or the position restricting engagement portion 182Bp) is engaged with the position restricting portion 277, and thus the lock member 180 is maintained in the lock position or the unlock position. Then, as a strong force is applied to the operating portion 181 to such an extent that the position restricting engagement portion 182Ap (or the position restricting engagement portion 182Bp) can pass over the position restricting portion 277, the lock member 180 can be moved.

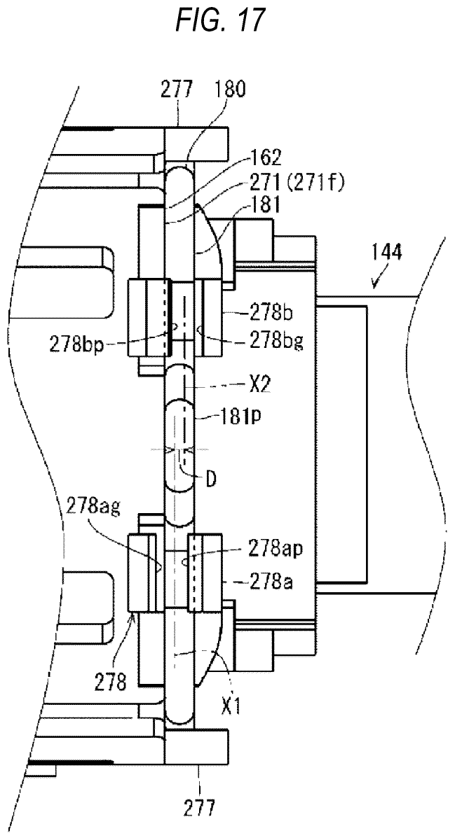

The locking side wall 271 includes a receiving portion 278 configured to receive the operating portion 181. FIG. 17 is a bottom view mainly illustrating the operating portion 181 and the receiving portion 278. As illustrated in FIGS. 12 to 17, the receiving portion 278 is a portion protruding from the lock member disposition surface 271f of the wall body 271B, similar to the receiving portion 78 in the first embodiment. In a state where the lock member 180 is in the unlock position, the receiving portion 278 is located inside the operating portion 181 and receives the operating portion 181. In a state where the lock member 180 is in the lock position, the operating portion 181 is disposed at a position separated outward from the receiving portion 278.

In the present embodiment, the receiving portion 278 includes the first receiving portion 278a and the second receiving portion 278b that are separated along the extending direction of the operating portion 181.

A first receiving groove 278ag into which the operating portion 181 can be fitted is formed in a portion of the first receiving portion 278a opposite to the rotation restricting portion 147. Similarly, a second receiving groove 278bg is formed in the second receiving portion 278b. The receiving grooves 278ag and 278bg are formed in a groove shape having a width sufficient to allow the operating portion 181 to be disposed therein. In a state where the lock member 180 is in the unlock position, the operating portion 181 is fitted into the receiving grooves 278ag and 278bg. This prevents the locking member 180 from moving from the unlock position to the lock position.

The first receiving portion 278a and the second receiving portion 278b is configured to receive an outer part of the operating protrusion 181p of the operating portion 181.

Therefore, the operating protrusion 181p protrudes to the side opposite to the rotation restricting portion 147 between the first receiving portion 278a and the second receiving portion 278b (see FIG. 16). In a state where the operating portion 181 is received by the first receiving portion 278a and the second receiving portion 278b, a top portion of the operating protrusion 181p is preferably located on a side away from the rotation restricting portion 147 than outer end portions of the first receiving portion 278a and the second receiving portion 278b. Accordingly, the operating protrusion 181p can be easily pushed in or pulled out between the first receiving portion 278a and the second receiving portion 278b.

The first receiving groove 278ag and the second receiving groove 278bg are displaced from each other in a direction orthogonal to the lock member disposition surface 271f. For example, an axis X1 at the center in a width direction of the first receiving groove 278ag and an axis X2 at the center in a width direction of the second receiving groove 278bg are displaced by a difference D in the direction orthogonal to the lock member disposition surface 271f.

The first receiving groove 278ag has a first retaining protrusion 278ap configured to engage with the operating portion 181 from a position close to the second receiving groove 278bg. The second receiving groove 278bg has a second retaining protrusion 278bp configured to engage with the operating portion 181 from a position close to the first receiving groove 278ag.

More specifically, the first retaining protrusion 278ap is formed near an outer edge of a surface of the first receiving groove 278ag on a side far from the lock member disposition surface 271f (see FIGS. 13, 15, and 17). The second retaining protrusion 278bp is formed near an outer edge of a surface of the second receiving groove 278bg on a side close to the lock member disposition surface 271f (see FIGS. 13, 15, and 17).

Then, in a state where the operating portion 181 is received by the receiving portion 278, the first retaining protrusion 278ap is engaged with the operating portion 181 from the side far from the lock member disposition surface 271f in the first receiving groove 278ag, and the second retaining protrusion 278bp is engaged with the operating portion 181 from the side close to the lock member disposition surface 271f in the second receiving groove 278bg.

In the normal state, the first receiving groove 278ag and the second receiving groove 278bg are displaced from each other, and each of the first retaining protrusion 278ap and the second retaining protrusion 278bp can be easily and firmly engaged with the operating portion 181. In a case where the operating portion 181 is to be displaced away from the lock member disposition surface 271f, the first retaining protrusion 278ap is firmly engaged with the operating portion 181, and when the operating portion 181 is to be displaced toward the lock member disposition surface 271f, the second retaining protrusion 278bp is firmly engaged with the operating portion 181. Therefore, the operating portion 181 is less likely to come off the receiving portion 278.

In addition, the configurations described in regard to the first holding portion 72A, the second holding portion 72B, the guide portion 74, the restricting wall 76, and the receiving portion 78 described in the first embodiment can be used as the configurations related to the first holding portion 272A, the second holding portion 272B, the guide portion 274, the restricting wall 276, the receiving portion 278, and the like.

An assembly procedure of the lock member 180 will be described.

In a state where the lock member 180 is disposed along the lock member disposition surface 271f as in the lock member 180 indicated by a two-dot chain line in FIG. 16, distal ends of the lock portions 84A and 84B are disposed on both outer sides of a distal end of the guide portion 274, and the operating portion 181 is disposed between the arcuate wall 275 and the receiving portion 278.

In this state, by operating the operating portion 181, the lock portions 84A and 84B are inserted between the lock member disposition surface 271f and the restricting wall 276 and are pushed toward both outer sides of the guide portion 274.

After the lock portions 84A and 84B come into contact with the widening guide end portion 274b and are pushed apart, the lock portions 84A and 84B are disposed on both outer surface sides of the guide body 274a (see the lock member 180 indicated by a solid line in FIG. 16).

The operating portion 181 is operated such that the operating portion 181 further moves in a direction away from the rotation restricting portion 147. Then, similar to the first embodiment, the first lock portion 84A is inserted between the rotation restricting portion 147 and the first holding portion 272A, and the second lock portion 84B is inserted between the rotation restricting portion 147 and the second holding portion 272B.

Since the rotation restricting portion 147 tends to rotate due to the biasing force of the biasing member 38, the first surface 147f1 and the second surface 147f2 push the lock portions 84A and 84B toward the holding portions 272A and 272B, respectively. By restricting the movement of the lock portions 84A and 84B in directions in which the holding portions 272A and 272B are separated from each other, the inclination of the first surface 147f1 and the second surface 147f2 is prevented, and the rotation of the rotation restricting portion 147 is restricted (see FIG. 14).

In this state, the position restricting engagement portions 182Ap and 182Bp are engaged with the position restricting portion 277 from the operating portion 181 side, and thus the lock member 180 is maintained in the lock position.

As described in the first embodiment, after the winding shaft 140 is wound in the winding direction, the rotation of the rotation restricting portion 147 is restricted by the lock member 180, and thus a pre-wound state can be maintained by the lock member 180.

The winding device 120 is assembled to the automobile 10 in a state in which the rotation of the winding shaft 140 is restricted. Thereafter, the rotation restriction of the winding shaft 140 is released.

That is, as described above, the operating portion 181 is firmly pushed toward the rotation restricting portion 147. Then, the position restricting engagement portions 182Ap and 182Bp release the engagement with the position restricting portion 277, and the lock portions 84A and 84B are released from between the rotation restricting portion 147 and the holding portions 272A and 272B, respectively, and move to both outer sides of the guide portion 274 (FIG. 16). Accordingly, the lock member 180 is in the unlock position. In this state, the operating portion 181 is received by the receiving portion 278. The position restricting engagement portions 182Ap and 182Bp are engaged with the position restricting portion 277 from the side opposite to the operating portion 181. Accordingly, the lock member 180 is maintained in the lock position.

In a state where the lock member 180 is in the unlock position, the rotation restriction state of the rotation restricting portion 147 by the lock portions 84A and 84B is released, and thus the winding shaft 140 can rotate in the housing 150 such that the sheet-shaped member 22 can be drawn out or wound.

In a case where the winding device 120 is removed from the automobile 10 for maintenance or other reasons, the lock member 180 moves from the unlock position to the lock position, thereby maintaining the winding shaft 140 in the rotation restriction state.

### Effects and the Like

According to the sheet-shaped member winding device 120 configured as described above, the same operations and effects as those of the first embodiment can be obtained except for the operations and effects obtained by the lock member 180 being disposed on the lock member disposition surface 271f side.

According to the winding device 120, since the lock member disposition surface 271f is a side surface facing the middle in the longitudinal direction of the winding shaft 140, and the rotation restricting portion 147 is a portion of the end portion of the winding shaft 140 that is located closer to the intermediate side in the longitudinal direction of the winding shaft 140 than the through hole 271h, the winding shaft 140 can be prevented from rotating inside the housing 150, making it easier to achieve a compact size.

It is not necessary to form a through hole on the outside of the housing 150 through which the end portion of the winding shaft protrudes. Therefore, oil for circulation in the bearing member 160 is less likely to leak to the outside, and external foreign matter is less likely to enter the bearing member 160.

The operating portion 181 includes an operating protrusion 181p that protrudes to the side opposite to the rotation restricting portion 147 between the first receiving portion 278a and the second receiving portion 278b. Therefore, for example, when pushing or pulling the operating protrusion 181p with a finger, the finger is less likely to interfere with the first receiving portion 278a and the second receiving portion 278b, the operating portion 181 can be easily pushed toward the first receiving portion 278a and the second receiving portion 278b, and the operating portion 181 can be easily operated in a direction away from the first receiving portion 278a and the second receiving portion 278b.

In addition, the first receiving groove 278ag and the second receiving groove 278bg are displaced from each other in the direction orthogonal to the lock member disposition surface 271f, and the first receiving groove 278ag and the second receiving groove 278bg include the first retaining protrusion 278ap and the second retaining protrusion 278bp that engage with the operating portion 181 from opposite sides, respectively. Therefore, in the normal state, the first retaining protrusion 278ap and the second retaining protrusion 278bp can be easily and firmly engaged with the operating portion 181. Therefore, the lock member 180 is more reliably maintained in the unlock position.

By engaging the position restricting engagement portions 182Ap and 182Bp of the lock member 180 with the position restricting portion 277 from the operating portion 181 side, the lock member 180 is maintained in the lock position. By engaging the position restricting engagement portions 182Ap and 182Bp to the position restricting portion 277 from the side opposite to the operating portion 181, the lock member 180 is maintained in the unlock position. The lock member 180 can be easily maintained in the lock position and the unlock position with a relatively simple configuration.

### Note

The configurations described in the above embodiments and modifications can be appropriately combined as long as the configurations do not contradict each other.

The present embodiment discloses the following aspects.

A sheet-shaped member winding device including:
a sheet-shaped member;
a winding shaft to which one end portion of the sheet-shaped member is attached;
a housing including a locking side wall having a lock member disposition surface and a through hole, the housing being configured to support the winding shaft such that the winding shaft is rotatable in a state where an end portion of the winding shaft passes through the through hole;
a biasing member configured to bias the winding shaft in a direction in which the sheet-shaped member is wound; and
a lock member configured to be moved between a lock position at which the lock member prevents rotation of the end portion of the winding shaft, and an unlock position at which the lock member allows rotation of the end portion of the winding shaft, on the lock member disposition surface side of the locking side wall,
in which the end portion of the winding shaft includes a rotation restricting portion whose rotation is restricted by the lock member, and the rotation restricting portion includes a first surface and a second surface that face in directions opposite to each other,
the lock member includes:
   an operating portion;
   a first intermediate portion and a second intermediate portion extending in the same direction from the operating portion with an interval between the first intermediate portion and the second intermediate portion;
   a first folded portion that is folded from a distal end of the first intermediate portion and folded toward a proximal end side of the first intermediate portion to pass through the second intermediate portion side;
   a second folded portion that is folded from a distal end of the second intermediate portion and folded toward a proximal end side of the second intermediate portion to pass through the first intermediate portion;
   a first lock portion extending from a distal end of the first folded portion along a direction in which the lock member moves; and
   a second lock portion extending from a distal end of the second folded portion along the direction in which the lock member moves,
the locking side wall includes a first holding portion and a second holding portion that are disposed with an interval between the first holding portion and the second holding portion, and the rotation restricting portion is disposed between the first holding portion and the second holding portion, and
in a state where the lock member is in the lock position, the first lock portion is disposed between the first surface and the first holding portion, and the second lock portion is disposed between the second surface and the second holding portion, and the first surface and the second surface push the first lock portion and the second lock portion in directions away from each other due to a rotational biasing force of the winding shaft by the biasing member, and
   the first holding portion and the second holding portion restrict movement of the first lock portion and the second lock portion in the directions away from each other, thereby restricting rotation of the rotation restricting portion.

According to this sheet-shaped member winding device, in a state where the lock member is in the lock position, the first holding portion and the second holding portion restrict the movement of the first lock portion and the second lock portion in the directions away from each other, thereby restricting the rotation of the rotation restricting portion. In this state, the first lock portion is sandwiched between the first surface and the first holding portion, and the second lock portion is sandwiched between the second surface and the second holding portion, whereby the lock member is maintained in the lock position.

In this state, the first surface pushes the first lock portion toward the first holding portion and the second surface pushes the second lock portion toward the second holding portion due to the rotational biasing force of the biasing member, and thus a backlash of the lock member is prevented.

To unlock the winding device, the lock member is simply pushed from the lock position toward the unlock position against the frictional force of the first lock portion against the first surface and the first holding portion and the frictional force of the second lock portion against the second surface and the second holding portion. Therefore, the unlock operation of the winding device can be easily performed.

A second aspect is a sheet-shaped member winding device according to the first aspect, in which
the lock member disposition surface is a side surface facing the middle in a longitudinal direction of the winding shaft, and
the rotation restricting portion is a portion of the end portion of the winding shaft that is located closer to an intermediate in a longitudinal direction of the winding shaft than is the through hole.

Accordingly, the winding shaft can be prevented from rotating inside the housing, making it easier to achieve a compact size.

A third aspect is the sheet-shaped member winding device according to the first aspect, in which
the lock member disposition surface is an outer side surface facing outward in a longitudinal direction of the winding shaft, and the rotation restricting portion is a protruding end portion protruding outward in the longitudinal direction of the winding shaft from the through hole.

Accordingly, the winding shaft can be prevented from rotating outside the housing, making it easier to operate the lock member.

A fourth aspect is the sheet-shaped member winding device according to any one of the first to third aspects, in which
in a state where the lock member is in the lock position, the first holding portion and the second holding portion are disposed at positions where the first holding portion and the second holding portion is configured to come into contact with the first folded portion and the second folded portion, respectively.

Accordingly, in a state where the lock member is in the lock position, the first holding portion and the second holding portion can come into contact with the first folded portion and the second folded portion, respectively. Therefore, in a state where the lock member is moved to the lock position, the lock member may be moved until the first folded portion and the second folded portion are brought into contact with the first holding portion and the second holding portion, respectively.

A fifth aspect is the sheet-shaped member winding device according to any one of the first to fourth aspects, in which
the locking side wall includes a receiving portion configured to, in a state where the lock member is in the unlock position, receive the operating portion from a side closer to the rotation restricting portion between the first intermediate portion and the second intermediate portion.

In this case, since the receiving portion receives the operating portion, the lock member can be easily maintained in the unlock position.

A sixth aspect is the sheet-shaped member winding device according to the fifth aspect, in which
the receiving portion includes a first receiving portion and a second receiving portion separated from the first receiving portion, and
the operating portion includes an operating protrusion protruding to a side opposite to the rotation restricting portion between the first receiving portion and the second receiving portion.

In this case, it is easy to push the operating portion toward the first receiving portion and the second receiving portion and to operate the operating portion in a direction away from the first receiving portion and the second receiving portion.

A seventh aspect is the sheet-shaped member winding device according to the fifth or sixth aspect, in which
the receiving portion includes:
   a first receiving portion including a first receiving groove; and
   a second receiving portion including a second receiving groove,
the first receiving groove and the second receiving groove are located so as to be displaced from each other in a direction orthogonal to the lock member disposition surface,
the first receiving groove includes a first retaining protrusion configured to engage with the operating portion from a position close to the second receiving groove, and
the second receiving groove includes a second retaining protrusion configured to engage with the operating portion from a position close to the first receiving groove.

In this case, the operating portion is less likely to come off the receiving portion.

An eighth aspect is the sheet-shaped member winding device according to any one of the first to seventh aspects, in which
the locking side wall includes a guide portion located, with respect to the rotation restricting portion, on a side closer to a gap between the first lock portion and the second lock portion of the lock member in the unlock position, the guide portion including a guide body having a width equal to or greater than a distance between the first surface and the second surface.

In this case, as the lock member is moved toward the lock position, the first lock portion and the second lock portion sandwich the guide portion, and a width equal to or greater than the distance between the first surface and the second surface is provided between the first lock portion and the second lock portion. Therefore, the first lock portion and the second lock portion are less likely to interfere with the rotation restricting portion, and are smoothly guided toward both outer sides of the rotation restricting portion. This makes it easier to lock the winding device.

A ninth aspect is the sheet-shaped member winding device according to the eighth aspect, in which
an interval between the first lock portion and the second lock portion of the lock member in an initial state is smaller than the width of the guide body.

In this case, in a state where the lock member is in the unlock position, the first lock portion and the second lock portion can sandwich the guide portion. This prevents the backlash of the locking member in an unlock state. The lock member can be easily maintained in the unlock position by the frictional force between the first lock portion and the second lock portion with respect to the guide portion.

A tenth aspect is the sheet-shaped member winding device according to the eighth or ninth aspect, in which
the guide portion includes a widening guide end portion located on a side opposite to the rotation restricting portion with respect to the guide body, the widening guide end portion having a width gradually increasing, toward the rotation restricting portion, from a width smaller than an interval between the first lock portion and the second lock portion of the lock member in an initial state to the width of the guide body.

In this case, the first lock portion and the second lock portion can be easily disposed on both sides of the guide portion. Therefore, the lock member can be easily assembled to the locking side wall.

An eleventh aspect is the sheet-shaped member winding device according to any one of the first to tenth aspects, in which
the locking side wall further includes a position restricting portion located adjacent to a movement path of at least one of the first intermediate portion and the second intermediate portion, and
at least one of the first intermediate portion and the second intermediate portion includes a position restricting engagement portion configured to:
   in a state where the lock member is in the lock position, engage with the position restricting portion from a side closer to the operating portion; and
   in a state where the lock member is in the unlock position engage with the position restricting portion from a side opposite to the operating portion.

Accordingly, the lock member can be maintained in the lock position by engaging the position restricting engagement portion with the position restricting portion from the operating portion side. The lock member can be maintained in the unlock position by engaging the position restricting engagement portion with the position restricting portion from a side opposite to the operating portion. Accordingly, the lock member can be easily maintained in the lock position and the unlock position with a relatively simple configuration.

While the present invention has been described in detail above, the above description is in all aspects illustrative and not restrictive. Various modifications described above can be applied in combination as long as the modifications do not contradict each other. It is understood that numerous modifications not illustrated may be devised without departing from the scope of the present invention.

The present application is based on Japanese Patent Application No. 2023-066490 filed on Apr. 14, 2023 and Japanese Patent Application No. 2024-000705 filed on Jan. 5, 2024, the contents of which are incorporated herein by reference.

1. A sheet-shaped member winding device comprising:
a sheet-shaped member;
a winding shaft to which one end portion of the sheet-shaped member is attached;
a housing including a locking side wall having a lock member disposition surface and a through hole, the housing being configured to support the winding shaft such that the winding shaft is rotatable in a state where an end portion of the winding shaft passes through the through hole;
a biasing member configured to bias the winding shaft in a direction in which the sheet-shaped member is wound; and
a lock member configured to be moved between a lock position and an unlock position on the lock member disposition surface side of the locking side wall, the lock member being configured to prevents rotation of the end portion of the winding shaft in a state where the lock member is in the lock position, and the lock member being configured to allows rotation of the end portion of the winding shaft in a state where the lock member is in the unlock position,
wherein the end portion of the winding shaft includes a rotation restricting portion whose rotation is restricted by the lock member, and the rotation restricting portion includes a first surface and a second surface that face in directions opposite to each other,
the lock member includes:
an operating portion;
a first intermediate portion and a second intermediate portion extending in the same direction from the operating portion with an interval between the first intermediate portion and the second intermediate portion;
a first folded portion that is folded from a distal end of the first intermediate portion and folded toward a proximal end of the first intermediate portion to pass through a portion closer to the second intermediate portion side than is the first intermediate portion;
a second folded portion that is folded from a distal end of the second intermediate portion and folded toward a proximal end of the second intermediate portion to pass through a portion closer to the first intermediate portion than is the second intermediate portion;
a first lock portion extending from a distal end of the first folded portion along a direction in which the lock member moves; and
a second lock portion extending from a distal end of the second folded portion along the direction in which the lock member moves,
the locking side wall includes a first holding portion and a second holding portion that are disposed with an interval between the first holding portion and the second holding portion, and the rotation restricting portion is disposed between the first holding portion and the second holding portion, and
in a state where the lock member is in the lock position, the first lock portion is disposed between the first surface and the first holding portion, the second lock portion is disposed between the second surface and the second holding portion, the first surface and the second surface push the first lock portion and the second lock portion in directions away from each other due to a rotational biasing force of the winding shaft by the biasing member, and the first holding portion and the second holding portion restrict movement of the first lock portion and the second lock portion in the directions away from each other, thereby restricting rotation of the rotation restricting portion.

2. The sheet-shaped member winding device according to claim 1,
wherein the lock member disposition surface is a side surface facing the middle in a longitudinal direction of the winding shaft, and
the rotation restricting portion is a portion of the end portion of the winding shaft that is located closer to an intermediate in a longitudinal direction of the winding shaft than is the through hole.

3. The sheet-shaped member winding device according to claim 1,
wherein the lock member disposition surface is an outer side surface facing outward in a longitudinal direction of the winding shaft, and
the rotation restricting portion is a protruding end portion protruding outward in the longitudinal direction of the winding shaft from the through hole.

4. The sheet-shaped member winding device according to claim 1,
wherein in a state where the lock member is in the lock position, the first holding portion and the second holding portion are disposed at positions where the first holding portion and the second holding portion is configured to come into contact with the first folded portion and the second folded portion, respectively.

5. The sheet-shaped member winding device according to claim 1,
wherein the locking side wall includes a receiving portion configured to, in a state where the lock member is in the unlock position, receive the operating portion from a side closer to the rotation restricting portion between the first intermediate portion and the second intermediate portion.

6. The sheet-shaped member winding device according to claim 5,
wherein the receiving portion includes:
a first receiving portion; and
a second receiving portion separated from the first receiving portion, and
the operating portion includes an operating protrusion protruding to a side opposite to the rotation restricting portion between the first receiving portion and the second receiving portion.

7. The sheet-shaped member winding device according to claim 5,
wherein the receiving portion includes:
a first receiving portion including a first receiving groove; and
a second receiving portion including a second receiving groove,
the first receiving groove and the second receiving groove are located so as to be displaced from each other in a direction orthogonal to the lock member disposition surface,
the first receiving groove includes a first retaining protrusion configured to engage with the operating portion from a position close to the second receiving groove, and
the second receiving groove includes a second retaining protrusion configured to engage with the operating portion from a position close to the first receiving groove.

8. The sheet-shaped member winding device according to claim 1,
wherein the locking side wall includes a guide portion located, with respect to the rotation restricting portion, on a side closer to a gap between the first lock portion and the second lock portion of the lock member in the unlock position, the guide portion including a guide body having a width equal to or greater than a distance between the first surface and the second surface.

9. The sheet-shaped member winding device according to claim 8,
wherein an interval between the first lock portion and the second lock portion of the lock member in an initial state is smaller than the width of the guide body.

10. The sheet-shaped member winding device according to claim 8,
wherein the guide portion includes a widening guide end portion located on a side opposite to the rotation restricting portion with respect to the guide body, the widening guide end portion having a width gradually increasing, toward the rotation restricting portion, from a width smaller than an interval between the first lock portion and the second lock portion of the lock member in an initial state to the width of the guide body.

11. The sheet-shaped member winding device according to claim 1,
wherein the locking side wall further includes a position restricting portion located adjacent to a movement path of at least one of the first intermediate portion and the second intermediate portion, and
at least one of the first intermediate portion and the second intermediate portion includes a position restricting engagement portion configured to:
in a state where the lock member is in the lock position, engage with the position restricting portion from a side closer to the operating portion; and
in a state where the lock member is in the unlock position, engage with the position restricting portion from a side opposite to the operating portion with respect to the position restricting portion.
